(19) United States
(12) Patent Application Publication
(10) Pub. No.: US 2026/0303154 A1
(43) Pub. Date: Oct. 1, 2026

(54) MIMO EQUALIZER CIRCUIT, COMMUNICATION UNIT AND METHOD FOR SUCCESSIVE INTERFERENCE CANCELLATION

(71) Applicant: AccelerComm Limited, Southampton (GB)

(72) Inventors: Siyao Lu, Southampton (GB); Robert Geoffrey Maunder, Southampton (GB); Xiaoyu Zhang, Southampton (GB); Mohammed El-Hajjar, Southampton (GB)

(21) Appl. No.: 19/479,373

(22) PCT Filed: May 16, 2024
(86) PCT No.: PCT/EP2024/035001

§ 371 Date: Oct. 28, 2025

(30) Foreign Application Priority Data
May 16, 2023 (GB) 2307298.6

(51) Int. Cl. H04B 7/0417; H04B 7/005; H04L 25/02

(52) U.S. Cl. CPC H04B 7/0417; H04B 7/005; H04L 25/0204

(57) ABSTRACT

A MIMO, equalizer circuit comprises an interference rejection combining-preprocessing circuit and a matrix extension circuit extends H2 produce a preprocessed channel estimate, H3 matrix; and an extended preprocessed received signal, y1, vector that produces an extended preprocessed received signal y2 vector from an inverted square root covariance matrix RI−½. A successive interference cancellation detection circuit uses an extended H3 matrix to perform successive interference cancellation to the y2 vector that produces an equalized signal vector x. The inverse square root matrix circuit comprises: a Schur decomposition circuit that converts the covariance matrix RI into an orthogonal eigenvectors matrix U and a real-valued diagonal matrix D; an inverse square root circuit generates an inverted square root real-valued diagonal matrix D−½; and a matrix manipulation circuit generate a B1 matrix from U and D−½.

### FIELD OF THE INVENTION

The field of the invention relates to a communication unit and methods for successive interference cancellation (SIC) in equalizers. The field of the invention is applicable to, but not limited to, Multiple-Input Multiple-Output (MIMO) equalisation for current and future generations of communication standards, particularly those that may employ successive interference cancellation (SIC) based Minimum Mean Square Error-Interference Rejection Combining (MMSE-IRC) equalizer circuits.

### BACKGROUND

The most promising wireless technologies that can effectively boost the data transmission rate also improve system coverage and enhance link reliability. FIG. 1 shows an example Multiple-Input Multiple-Output (MIMO) communication system where the number of transmit antenna elements is equal to the number N_{T} of transmit antenna ports, and the number of receive antenna elements is equal to the number N_{R} of receive antenna ports. Here, the information bits 102 to be transmitted are mapped to quadrature amplitude modulated (QAM) symbols by a QAM mapper 103. These QAM symbols are mapped to N_{L} transmission layers by a layer mapper 104. Then a MIMO precoder 105 is used for projecting the QAM symbols on the transmission layers onto N_{T} transmit antenna ports.

Explicitly, a precoding matrix generated by the precoder is applied to the QAM symbols on the transmission layers, where the precoding matrix has a first dimension of the number of transmission layers N_{L} and a second dimension of the number of transmit antenna ports N_{T}, allowing the number of transmission layers in a MIMO communications system to be varied at run-time, even though the number of transmit and receive antenna elements are fixed for a given device. Specifically, the demodulation reference signal (DM-RS) symbols 132 from N_{L} layers are generated by a DM-RS generator 130 according to the reference signal configuration 131. The DM-RS symbols are projected onto N_{T} transmit antenna ports by the precoder. The precoded symbols are mapped to the allocated physical resources by an RE mapper 106, followed by digital beamforming 107, orthogonal frequency division multiplex (OFDM) modulation 108, cyclic prefix (CP) insertion and analogue beamforming 109. Finally, a radio frequency (RF) stage 110 is used to deliver the signals to the set of transmit antenna elements, which may outnumber the N_{T} transmit antenna ports in the case of beamforming, particularly in the downlink. Note that in some applications, some or all of precoding, digital beamforming and analogue beamforming may be omitted or merged together. Then the OFDM symbols are simultaneously transmitted by the transmit antenna elements 111 and arrive at the receive antenna elements 113, where the received signals are corrupted by the fading channel 112, the noise 114, and the inter-cell or inter-user interference 133, as will be detailed in the sections below.

The RF stage 110 of the receiver collects the signals at the output of each receive antenna element 113, followed by the analogue beamforming 116, OFDM demodulation 117, CP removal and digital beamforming 118, which produce signals for the receive antenna ports, which may be outnumbered by the receive antenna elements. In the case of multi-user MIMO with beamforming in the uplink, each user that is co-scheduled onto the same time and frequency resource may be represented by a different subset of these receive antenna ports, perhaps with some residual interference from the other co-scheduled users. The number of receive antenna ports allocated to a particular user's received signal may be represented by N_{R}, which may vary at run-time, depending on how many co-scheduled users there are. For example, a receiver may have ‘64’ receive antenna elements, which are beamformed to provide ‘16’ receive antenna ports.

At times when there are, say, eight co-scheduled users, each of these users may be allocated a different set of N_{R}=2 of these receive antenna ports. At other times, there may be, say, sixteen co-scheduled users, with each being allocated N_{R}=1 of these receive antenna ports. Hence, the number of receive antenna ports N_{R} allocated to a particular user may vary at run-time. Note that in some applications, some or all of precoding, digital beamforming and analogue beamforming may be omitted or merged together. The demodulated frequency-domain signals of a particular user's N_{R} receive antenna ports are demapped by the RE demapper 119 and followed by operations of obtaining the channel estimate matrix H 121 by using the channel estimator 120 and obtaining the equalized signals 126 by the MIMO equalizer 125. Specifically, as illustrated in FIG. 1, the signals are mixed together by the multipath channels in the air, where the channel estimator tries to estimate the knowledge of the multipath channels 112 and the channel estimate matrix H 121 will be used by the MIMO equalizer 125 for recovering the mixed signals, where the operation of MIMO deprecoding has been integrated into the channel estimator 120.

The MIMO equalized signals on N_{L} layers 126 are then demapped into a symbol sequence by using a layer demapper 127. The symbol sequence is typically demapped into soft bits or hard bits 129 by a QAM demapper 128. Like hard bits, soft bits express what the most likely value of each bit is. However, unlike hard bits, soft bits also express how likely this bit value is. Soft bits are typically represented using Logarithmic Likelihood Ratios (LLRs), where LLR=ln[Pr(bit=0)/Pr(bit=1)] in some applications and LLR=ln[Pr(bit=1)/Pr(bit=0)] in some other applications. Specifically, the MIMO equalizer plays a significant role for combating intersymbol interference, wherein the minimum mean square error (MMSE) and MMSE interference rejection combining (MMES-IRC) criterion-based MIMO equalizers have been considered the baseline MIMO equalizer in 3GPP standards [1], as detailed in the sections below.

### Linear MMSE Equalizer

Explicitly, the MMSE criterion-based MIMO equalizer is based on the received signals from the receive antenna ports and channel estimates and aimed to get the optimized signal-to-noise ratio (SNR) for the estimated signal z_{MMSE}. An MMSE equalizer circuit comprises a first input that accepts the received signal from receive antenna ports, a second input that accepts channel estimates, a third input that accepts noise power scalar and an output that provides the equalized signal z_{MMSE}. Considering an example MIMO system where the number of transmit antenna elements 111 happens to be equal to the number N_{T} of transmit antenna ports and the number of receive antenna elements 113 happens to be equal to the number N_{R} of receive antenna ports as shown in FIG. 1, after the transmission over the fading channel, the frequency-domain received signal at a particular receiver can then be expressed as

$$y = Hs + n , \qquad ( 1 )$$

$$Where :$$

$$H = [ \begin{matrix}{h}_{11} & … & {h}_{1 {N}_{L}} \\ ⋮ & ⋱ & ⋮ \\ {h}_{{N}_{R} 1} & … & {h}_{{N}_{R} {N}_{L}}\end{matrix} ]$$

and H matrix represents the frequency-domain channel estimate, s=[s₁, s₂, . . . , s_{NL}]^{T} represents the symbol vectors transmitted through the N_{L} layers, y=[y₁, y₂, . . . , y_{NR}]^{T} represents the frequency-domain received observation signal, and n=[n₁, n₂, . . . , n_{NR}]^{T} is the noise vector included in the received observation. Note that in cases where the number of transmit or receive antenna elements is greater than the corresponding number of antenna ports owing to the use of beamforming, the channel matrix H can be considered to be an effective channel between the N_{L} transmission layers and the N_{R} receive antenna ports, as will be further detailed below. Here, the channel matrix H effectively consolidates the effect of MIMO precoding, transmit beamforming, OFDM modulation, time domain channel effects, OFDM demodulation and receive beamforming.

In a linear equalizer, the equalized signal f_{MMSE}=G_{MMSE}y is obtained by multiplying the received signal vector y with a filter matrix G_{MMSE}, followed by a parallel decision on all layers. When the MMSE equalizer is considered, the filter matrix G_{MMSE} is chosen such that the mean-square-error (MSE) between the transmitted signal vector s and its estimate vector f_{MMSE} is minimized. Specifically, the minimization problem for the MMSE equalizer can be formed as [2]:

$${G}_{MMSE} = arg {min}_{{G}_{M M S E}} E [ {‖ s - {f}_{M M S E} ‖}^{2} ] . \qquad ( 2 )$$

Where: arg min{ } is the argument of the minimum, E[ ] is the expectation operation, and ∥0.1∥ is the Frobenius norm.

The minimization of Equation (1) yields the filter matrix as:

$${W}_{M M S E} = H {H}^{H} + {σ}_{n}^{2} I . \qquad ( 3 )$$

$${G}_{M M S E} = {H}^{H} {W}_{MMSE}^{- 1} .$$

where σₙ² is the noise variance, (.)^{H} denotes the Hermitian transpose of a vector or a matrix, I is an identity matrix of dimension (N_{R}×N_{R}) and W_{MMSE} is the autocorrelation matrix of the received signal vector.

When the MMSE criterion shown in Equation (2) is achieved, the decision statistics can be expressed as

$${f}_{M M S E} = {G}_{MMSE} y = {G}_{M M S E} Hs + {G}_{MMSE} n . \qquad ( 4 )$$

where f_{MMSE}=[(f_{MMSE})₁, (f_{MMSE})₂, . . . , (f_{MMSE})_{NL}]^{T} is the filtered received signal vector. Additionally, the filter vector (G_{MMSE})ᵢ for detecting the symbol sᵢ is given by:

$${( {G}_{M M S E} )}_{i} = {H ( : , i )}^{H} {( H {H}^{H} + {σ}_{n}^{2} I )}^{- 1} . ( i = 1 , … , {N}_{L} ) \qquad ( 3 b )$$

where H(:,i) represents the i-th column vector of the channel estimate matrix. Then, by using Equation (3b), the filtered receive symbol (f_{MMSE})ᵢ can be written as:

$${( {f}_{M M S E} )}_{i} = {( {G}_{M M S E} )}_{i} H ( : , i ) {s}_{i} + {( {G}_{M M S E} )}_{i} {n}_{i} . ( i = 1 , … , {N}_{L} ) \qquad ( 4 b )$$

According to Equation (4b), the equalisation gain (μ_{MMSE})ᵢ and the variance (β_{MMSE})ᵢ of the filtered symbol (f_{MMSE})ᵢ can be expressed as:

$${( {μ}_{M M S E} )}_{i} = {( {G}_{M M S E} )}_{i} H ( : , i ) , \qquad ( 4 c )$$

$${( {β}_{M M S E} )}_{i} = {{σ}_{n}^{2} ( {G}_{M M S E} )}_{i} {( {G}_{M M S E} )}_{i}^{H} . ( i = 1 , … , {N}_{L} ) \qquad ( 4 d )$$

Consequently, the estimated QAM symbol (z_{MMSE})ᵢ for the transmitted symbol sᵢ at the i-th transmission layer can be rewritten as:

$${( {z}_{M M S E} )}_{i} = \frac{{( {f}_{MMSE} )}_{i}}{{( {μ}_{MMSE} )}_{i}} ( i = 1 , … , {N}_{L} ) \qquad ( 4 e )$$

and the noise variance (v_{MMSE})ᵢ which will be used to calculate soft bits can be rewritten as:

$${( {v}_{M M S E} )}_{i} = \frac{{( {β}_{M M S E} )}_{i}}{{\vert {( {μ}_{M M S E} )}_{i} \vert}^{2}} ( i = 1 , … , {N}_{L} ) \qquad ( 4 f )$$

The estimated vector constructed by (z_{MMSE})ᵢ expressed in Equation (4e) will be demapped into a sequence by the layer demapper and then will be demapped into soft bits or hard bits 129 by the QAM demapper. The soft bits are typically represented by using LLRs, where the noise variance (v_{MMSE})ᵢ in Equation (4f) will be used to calculate LLRs, which can be expressed as:

$$L L R = ln \frac{P ( bit = 0 )}{P ( bit = 1 )}$$

Where: P(bit=0) denotes the probability of bit equals to 0 and P(bit=1) denotes the probability of bit equals to 1 and the soft bits are expressed using LLRs.

For example, after having the equalized symbols in Equation (4e) and the noise variance in Equation (40, if QPSK modulation where each symbol has two bits is used, it is possible to derive the corresponding two LLRs as:

$$L L {R}_{1} = \frac{4}{{( {v}_{M M S E} )}_{i}} Im ( {( {z}_{M M S E} )}_{i} )$$

$$LL {R}_{2} = \frac{4}{{( {v}_{M M S E} )}_{i}} R e ( {( {z}_{M M S E} )}_{i} )$$

where LLR₁ is the LLR for the first bit in a QPSK symbol, LLR₂ is the LLR for the second bit in the QPSK symbol, and Re(.) and Im(.) are the real and imaginary parts of (.), respectively.

### MMSE-IRC Equalizer

With the evolution of electronic hardware and MIMO techniques, inter-cell or inter-user interference suppression techniques, whose application was previously limited by their large computational burden, may now be cost-effectively implemented in receivers. Specifically, interference rejection combining (IRC) is a linear combining technique that relies on multiple receive antenna ports and estimates of the interfering channels to project the received signals on a subspace in which the MSE is minimized [3]. IRC represents an add-on to the known minimum mean square error (MMSE) criterion. Compared with the MMSE criterion-based MIMO equalizer in Equation (3), the MMSE-IRC criterion based MIMO equalizer not only considers the noise, but also considers the inter-cell or inter-user interference as illustrated in FIG. 1, wherein the interference plus noise is estimated in the MMSE-IRC criterion based MIMO equalizer to get the optimized signal-to-interference-plus-noise ratio (SINR) for the estimated signal z_{IRC}.

Considering an example MIMO system where the number of transmit antenna elements 111 happens to be equal to the number N_{T} of transmit antenna ports and the number of receive antenna elements 113 happens to be equal to the number N_{R} of receive antenna ports for both the target user and the interferers as shown in FIG. 1, after the transmission over the fading channel, the frequency-domain received signal at a particular receiver can then be expressed as

$$y = H s + {H}_{I} {s}_{I} + n , \qquad ( 5 )$$

$$Where :$$

$$H = [ \begin{matrix}{h}_{11} & ⋯ & {h}_{1 {N}_{L}} \\ ⋮ & ⋱ & ⋮ \\ {h}_{{N}_{R} 1} & ⋯ & {h}_{{N}_{R} {N}_{L}}\end{matrix} ]$$

$${H}_{I} = [ \begin{matrix}{h}_{I} ( 1 , 1 ) & ⋯ & {h}_{I} ( 1 , {N}_{L} ) \\ ⋮ & ⋱ & ⋮ \\ {h}_{I} ( {N}_{R} , 1 ) & ⋯ & {h}_{I} ( {N}_{R} , {N}_{L} )\end{matrix} ]$$

and H matrix represent the frequency-domain channel matrices for the target user, s=[s(1), s(2), . . . , s(N_{L})]^{T} represents the symbol vector transmitted by the target user, H_{I} matrix represent the channel matrix and the transmitted symbols for the interferer, respectively, y=[y(1), y(2), . . . , y(N_{R})]^{T} represents the frequency-domain received observation vector, and n=[n(1), n(2), . . . , n(N_{R})]^{T} is the noise vector included in the received observation. Note that in cases where the number of transmit or receive antenna elements is greater than the corresponding number of antenna ports owing to the use of beamforming, the channel matrices H and H_{I} can be considered to be effective channels between the N_{L} transmission layers of the desired and interfering users and the N_{R} receive antenna ports, as will be further detailed below. Here, the channel matrices H and H_{I} effectively consolidate the effect of MIMO precoding, transmit beamforming, OFDM modulation, time domain channel effects, OFDM demodulation and receive beamforming. Note further that there is no requirement for the interfering user to be using the same system parameters as the desired user, or even using the same waveform. Indeed, the interference could be derived from any RF signal from any number of sources or users in a practical system.

The minimization formulation can be expressed as

$${G}_{IRC} = arg {min}_{{G}_{IRC}} E [ {‖ s - {f}_{IRC} ‖}^{2} ] . \qquad ( 6 )$$

where: arg min{ } is the argument of the minimum, E[ ] is the expectation operation, and ∥.∥ is the Frobenius norm.

The minimization formulation in Equation (6) yields the MMSE-IRC filter G_{IRC} matrix as

$${W}_{IRC} = H {H}^{H} + {R}_{I} \qquad ( 7 )$$

$${G}_{IRC} = {H}^{H} {W}_{IRC}^{- 1} ,$$

wherein H matrix represents the channel estimate for the target user, (.)^{H} denotes the Hermitian transpose of a vector or a matrix, covariance matrix R_{I} 123 represents the covariance matrix of the interference plus noise and W_{IRC} is the autocorrelation matrix of the received signal vector. Specifically, to obtain the MMSE-IRC criterion based filter matrix as shown in Equation (7), the covariance matrix including the sources of inter-cell/inter-user interference and noise needs to be estimated. In the example of 3GPP NR, the covariance matrix may be estimated from the demodulation reference symbol (DM-RS) subcarriers by following equations:

$${R}_{I} = \frac{1}{{N}_{SP}} \sum {R}_{IPN} \qquad ( 7 b )$$

$${R}_{IPN} = ( y - H {s}_{D M R S} ) {( y - H {s}_{D M R S} )}^{H} \qquad ( 7 c )$$

where the DM-RS symbols 132 s_{DMRS} are used to estimate the covariance matrix, and Nₛₚ is the number of DM-RS symbols within each averaging unit for different DM-RS patterns 131.

A skilled practitioner would recognise that the covariance matrix can be calculated using pilot symbols or other techniques in various MIMO applications besides 3GPP NR. Furthermore, rather than averaging over various DM-RS signals, a skilled practitioner would recognise that other time domain or frequency domain interpolation techniques could be employed to obtain the covariance matrix R_{I}.

When the MMSE-IRC criterion is achieved, the decision statistics can be expressed as

$${f}_{IRC} = {G}_{IRC} y = {G}_{IRC} H s + {G}_{IRC} ( {H}_{I} {s}_{I} + n ) . \qquad ( 8 )$$

where f_{IRC}=[(f_{IRC})₁, (f_{IRC})₂, . . . , (f_{IRC})_{NL}]^{T} is the filtered received signal vector.

Additionally, the filter vector (G_{IRC})ᵢ for detecting the symbol sᵢ is given by:

$${( {G}_{l R C} )}_{i} = {H ( : , i )}^{H} {( H {H}^{H} + {R}_{1} )}^{- 1} . ( i = 1 , … , {N}_{L} )$$

Where: H(:,i) represents the i-th column vector of the channel estimate matrix.

Then, by using Equation (3b), the filtered receive symbol (f_{IRC})ᵢ can be written as

$${( {f}_{IRC} )}_{i} = {( {G}_{IRC} )}_{i} H ( : , i ) {s}_{i} + {( {G}_{IRC} )}_{i} {\overline{n}}_{i} \cdot ( i = 1 , … , {N}_{L} ) \qquad ( 8 b )$$

According to Equation (4b), the equalisation gain (μ_{IRC})ᵢ and the variance (β_{IRC})ᵢ of the filtered symbol (f_{IRC})ᵢ can be expressed as:

$${( {μ}_{IRC} )}_{i} = {( {G}_{IRC} )}_{i} H ( : , i ) , \qquad ( 8 c )$$

$${( {β}_{IRC} )}_{i} = {( {G}_{IRC} )}_{i} {{R}_{I} ( {G}_{IRC} )}_{i}^{H} \cdot ( i = 1 , … , {N}_{L} ) \qquad ( 8 d )$$

Consequently, the estimated QAM symbol (z_{IRC})ᵢ for the transmitted symbol sᵢ at the i-th transmission layer can be rewritten as:

$${( {z}_{IRC} )}_{i} = \frac{{( {f}_{IRc} )}_{i}}{{( {μ}_{IRc} )}_{i}} ( i = 1 , … , {N}_{L} ) \qquad ( 8 e )$$

And the noise variance (v_{IRC})ᵢ which will be used to calculate soft bits can be rewritten as:

$${( {v}_{IRC} )}_{i} = \frac{{( {β}_{IRC} )}_{i}}{{\vert {( {μ}_{IRC} )}_{i} \vert}^{2}} ( i = 1 , … , {N}_{L} ) \qquad ( 8 f )$$

The estimated vector constructed by (z_{IRC})ᵢ expressed in Equation (4e) will be demapped into a sequence by the layer demapper and then will be demapped into soft bits or hard bits 129 by the QAM demapper. The soft bits are typically represented by using LLRs, where the noise variance (v_{IRC})ᵢ in Equation (4f) will be used to calculate LLRs, which can be expressed as:

$$L L R = ln \frac{P ( bit = 0 )}{P ( bit = 1 )}$$

Where: P(bit=0) denotes the probability of bit equals to 0 and P(bit=1) denotes the probability of bit equals to 1 and the soft bits are expressed using LLRs.

For example, after having the equalized symbols in Equation (8e) and the noise variance in Equation (8f), if QPSK modulation where each symbol has two bits is used, it is possible to derive the corresponding two LLRs as

$$L L {R}_{1} = \frac{4}{{( {v}_{IRC} )}_{i}} Im ( {( {z}_{IRC} )}_{i} )$$

$$LL {R}_{2} = \frac{4}{{( {v}_{IRC} )}_{i}} R e ( {( {z}_{IRC} )}_{i} )$$

where LLR₁ is the LLR for the first bit in a QPSK symbol, LLR₂ is the LLR for the second bit in the QPSK symbol, and Re(.) and Im(.) are the real and imaginary parts of (.), respectively.

However, the inventors have identified that the literature lacks a technique for combining MMSE-IRC processing with non-linear processing. These two have been demonstrated separately, where MMSE-IRC has the advantage of interference rejection and low complexity, but the disadvantage of degraded equalisation capability. Meanwhile, non-linear processing has a benefit of improved equalisation capability, but the disadvantage of high complexity, particularly when performing interference rejection. The literature does not offer a technique for combining MMSE-IRC processing with non-linear processing, while retaining the advantages of both, without being burdened by their disadvantages.

### SUMMARY

Examples herein described provide MIMO equalizers and methods for MIMO equalisation. In particular examples herein described detail algorithms that are suited to hardware implementation, enabling high throughputs to be achieved in a cost-efficient manner. Specific example embodiments are set forth in the dependent claims. These and other aspects will be apparent from, and elucidated with reference to, the example embodiments described hereinafter.

In a first aspect, a multiple-input multiple-output, MIMO, equalizer circuit comprises: controller; an inverse square root matrix circuit operably coupled to the controller and having a first input operable to receive a covariance matrix R_{I} and configured to perform an inverse square root operation to the covariance matrix R_{I} and output an inverted square root covariance matrix R_{I}^{-1/2} to a first output; an interference rejection combining (IRC)-preprocessing circuit operably coupled to the controller and the inverse square root matrix circuit and comprises a channel estimate matrix H input and a received signal vector y input wherein the IRC-preprocessing circuit is configured to: multiply the inverted square root covariance matrix R_{I}^{-1/2} and a channel estimate matrix H that generates a preprocessed channel estimate H2 matrix provided to a second output; and multiply the inverted square root covariance matrix R_{I}^{-1/2} and the received signal vector y that generates a preprocessed received signal y1 vector provided to a third output; a matrix extension circuit operably coupled to the controller and the second output and third output of the IRC-preprocessing circuit, wherein the matrix extension circuit is configured to: extend the preprocessed channel estimate H2 matrix that produces a preprocessed channel estimate H3 matrix provided to a fourth output; and extend the preprocessed received signal y1 vector that produces an extended preprocessed received signal y2 vector provided to a fifth output; and a successive interference cancellation, SIC, detection circuit operably coupled to the controller and the fourth output and fifth output of the matrix extension circuit, wherein the SIC detection circuit is configured to use the extended preprocessed channel estimate H3 matrix to perform successive interference cancellation to the extended preprocessed received signal y2 vector that produces an equalized signal vector x. The inverse square root matrix circuit comprises: a Schur decomposition circuit operably coupled to the first input and configured to convert the covariance matrix R_{I} into an orthogonal eigenvectors matrix U (804) and a real-valued diagonal matrix D; an inverse square root circuit operably coupled to the Schur decomposition circuit configured to perform an inverse square root operation that converts the real-valued diagonal matrix D into an inverted square root real-valued diagonal matrix D^{-1/2} (807); and a matrix manipulation circuit operably coupled to the Schur decomposition circuit and the inverse square root circuit and configured to generate a B1 matrix from the orthogonal eigenvectors matrix U and the inverted square root real-valued diagonal matrix D^{-1/2} to the first output. In this manner, linear MMSE-IRC processing is combined with non-linear processing, offering the advantage of interference rejection, low complexity, and improved equalisation capability. In this manner, the B1 matrix is calculated with low complexity.

In an optional example of the MIMO equalizer circuit, the covariance matrix R_{I} may have a first dimension equal to a number of spatial streams N_{R} and a second dimension equal to the number of spatial streams N_{R}, wherein the channel estimate matrix H has a first dimension equal to the number of spatial streams N_{R} and a second dimension equal to a number of layers N_{L}, and wherein the received signal vector y has a length equal to the number of spatial streams N_{R}, and the equalized signal vector x has a length equal to the number of layers N_{L}. In this manner, the MIMO equalizer circuit may support multiple spatial streams and multiple layers.

In an optional example of the MIMO equalizer circuit, the number of spatial streams N_{R} and for the number of layers N_{L} may vary between operations of the MIMO equalizer circuit at run-time. In this manner, the MIMO equalizer circuit may support transmissions from multiple transmitters employing different numbers of layers and may operate with beamforming combiners which allocate different numbers of spatial streams to recover the transmissions from different transmitters.

In an optional example of the MIMO equalizer circuit, the inverted square root covariance matrix R_{I}^{-1/2} may have a first dimension equal to the number of spatial streams N_{R} and a second dimension equal to the number of spatial streams N_{R}, and wherein the preprocessed channel estimate H2 matrix has a first dimension equal to the number of spatial streams N_{R} and a second dimension equal to the number of layers N_{L}, and wherein the y1 vector has a length equal to the number of spatial streams N_{R}, and the extended preprocessed received signal y2 vector has a length equal to the sum of the number of spatial streams and the number of layers, N_{R}+N_{L}, and wherein the extended preprocessed channel estimate H3 matrix has a first dimension equal to a sum of the number of spatial streams and the number of layers, N_{R}+N_{L}, and a second dimension equal to the number of layers N_{L}. In this manner, the MIMO equalizer circuit may support multiple spatial streams and multiple layers.

In an optional example of the MIMO equalizer circuit, the matrix manipulation circuit may further comprise: a Hermitian transpose circuit configured to perform a Hermitian transpose that converts the orthogonal eigenvectors matrix U into a Hermitian transposed U2 matrix; and a matrix multiplication circuit operably coupled to an output of the Hermitian transpose circuit and configured to convert the orthogonal eigenvectors matrix U, the inverse square root real-valued diagonal matrix D^{-1/2}, and the Hermitian transposed U2 matrix into the B1 matrix. In this manner, the B1 matrix may be calculated with low complexity.

In an optional example of the MIMO equalizer circuit, the MIMO equalizer circuit may further comprise a first switch that operates under the direction of the controller, wherein: in a first mode of operation the first switch is configured to receive and output the covariance matrix R_{I}; and in a second mode of operation the MIMO equalizer further comprises a covariance matrix generator circuit operably coupled to the first switch and configured to receive a noise power scalar, wherein the covariance matrix generator circuit uses the noise power scalar to generate a diagonal covariance matrix that is provided to the first switch and the first switch outputs the diagonal covariance matrix as the covariance matrix R_{I}. In this manner, interference rejection combining may be enabled or disabled at run-time, depending on which may be expected to provide the best signal reconstruction quality.

In an optional example of the MIMO equalizer circuit, the inverse square root matrix circuit may further comprise a second switch operably coupled to the controller and a diagonal inverse square root circuit and configured to support: a third mode of operation wherein the B1 matrix provides the inverted square root covariance matrix R_{I}^{-1/2}; and a fourth mode of operation wherein the diagonal inverse square root circuit performs a diagonal inverse square root operation that converts the covariance matrix R_{I} into a B2 matrix and wherein the B2 matrix provides the inverted square root covariance matrix R_{I}^{-1/2}. In this manner, he Schur decomposition may be enabled or disabled at run-time, depending on which may be expected to provide the best signal reconstruction quality.

In an optional example of the MIMO equalizer circuit, the SIC detection circuit may further comprise: a QR decomposition, QRD, circuit operable to perform a QR decomposition that converts the extended preprocessed channel estimate H3 matrix into an orthogonal unitary matrix Q and an upper triangular matrix R under direction of the controller, and a Gaussian elimination circuit operably coupled to the QRD, circuit and configured to perform Gaussian elimination that converts the orthogonal unitary matrix Q, the upper triangular matrix R and the extended preprocessed received signal y2 vector into the equalized signal vector output under direction of the controller. In this manner, the equalized signal vector output may be generated with low complexity.

In an optional example of the MIMO equalizer circuit, the SIC detection circuit may comprise a third switch operably coupled to the controller and the controller configures the SIC detection circuit via the third switch to operate in: a fifth mode of operation, when the QRD circuit does not employ a sorting process; and a sixth mode of operation when the QRD circuit does employ a sorting process. In this manner, sorting may be enabled or disabled at run-time, depending on which may be expected to provide the best signal reconstruction quality.

In an optional example of the MIMO equalizer circuit, the Gaussian elimination circuit may be operably coupled to a fourth switch operably coupled to the controller and the controller configures the Gaussian elimination circuit via the fourth switch to operate in a seventh mode of operation that employs quantization and an eighth mode of operation where the Gaussian elimination circuit does not employ quantization. In this manner, quantisation may be enabled or disabled at run-time, depending on which may be expected to provide the best signal reconstruction quality.

In an optional example of the MIMO equalizer circuit, the MIMO equalizer circuit may further comprise a noise variance calculation circuit operably coupled to the controller and configured to convert the upper triangular matrix R and the orthogonal unitary matrix Q into a noise variance vector v under the direction of the controller. In this manner, a noise variance vector may be generated to support QAM demapping.

In a second aspect, a communication unit comprising the MIMO equalizer circuit according to the first aspect is described. In this manner, linear MMSE-IRC processing is combined with non-linear processing in the communication unit, offering the advantage of interference rejection, low complexity, and improved equalisation capability.

In a third aspect, a method of performing multiple-input multiple-output, MIMO, equalization comprises: at an inverse square root matrix circuit: receiving a covariance matrix R_{I}; converting, by a Schur decomposition circuit, the covariance matrix R_{I} into an orthogonal eigenvectors matrix U and a real-valued diagonal matrix D; performing an inverse square root operation that converts the real-valued diagonal matrix D into an inverted square root real-valued diagonal matrix D^{-1/2} by an inverse square root circuit operably coupled to the Schur decomposition circuit; generating a B1 matrix from an orthogonal eigenvectors matrix U and the inverted square root real-valued diagonal matrix D^{-1/2}, by a matrix manipulation circuit operably coupled to the Schur decomposition circuit and the inverse square root circuit; and outputting an inverted square root covariance matrix R_{I}^{-1/2} receiving a covariance matrix R_{I} by an inverse square root matrix circuit and outputting an inverted square root covariance matrix R_{I}^{-1/2}. The method further comprises: receiving by an interference rejection combining (IRC)-preprocessing circuit the inverted square root covariance matrix R_{I}^{-1/2}, a channel estimate matrix H, and a received signal vector y; multiplying the inverted square root covariance matrix R_{I}^{-1/2} and the channel estimate matrix H and generating a preprocessed channel estimate H2 matrix; multiplying the inverted square root covariance matrix R_{I}^{-1/2} and the received signal vector y and generating a preprocessed received signal y1 vector; extending the preprocessed channel estimate H2 matrix by a matrix extension circuit and producing a preprocessed channel estimate H3 matrix; extending the preprocessed received signal y1 vector and producing an extended preprocessed received signal y2 vector; and receiving by a successive interference cancellation, SIC, detection circuit the extended preprocessed channel estimate H3 matrix, and using the extended preprocessed channel estimate H3 matrix to perform successive interference cancellation to the extended preprocessed received signal y2 vector and outputting an equalized signal vector x. In this manner, linear MMSE-IRC processing is combined with non-linear processing, offering the advantage of interference rejection, low complexity, and improved equalisation capability.

### BRIEF DESCRIPTION OF THE DRAWINGS

Further details, aspects and embodiments will be described, by way of example only, with reference to the drawings. In the drawings, like reference numbers are used to identify like or functionally similar elements. Elements in the FIG's are illustrated for simplicity and clarity and have not necessarily been drawn to scale.

FIG. 1 illustrates a known schematic of an example physical layer uplink transceiver signal processing operations for an example of a MIMO system where the number of transmit antenna elements happens to be equal to the number N_{T} of transmit antenna ports and the number of receive antenna elements happens to be equal to the number N_{R} of receive antenna ports.

FIG. 2 illustrates a known representation of the covariance matrix examples from a MIMO equalizer.

FIG. 3 illustrates a MIMO equalizer circuit for the operation of a MMSE-IRC with SIC MIMO equalizer according to some examples.

FIG. 4 illustrates a SIC detection circuit for an example embodiment of the MMSE-IRC with SIC MIMO equalizer according to some examples.

FIG. 5 illustrates a known representation of the QPSK constellation diagram for an example embodiment of the quantization operation according to some examples.

FIG. 6 illustrates an implementation circuit for the operation of a matrix-extension based MMSE-SIC with IRC MIMO equalizer according to some examples.

FIG. 7 illustrates a table to show the simulation limits and simulation parameters for the operation of a MIMO equalizer according to some examples.

FIG. 8 illustrates an example simulation result for the operation of the MMSE-IRC with SIC MIMO equalizer according to some examples.

FIG. 9 illustrates an example simulation result for the operation of the matrix-extension based MMSE-SIC with IRC MIMO equalizer according to some examples.

FIG. 10 illustrates a typical computing system that may be employed in an electronic device or a wireless communication unit to perform MIMO equalizer in accordance with some example embodiments.

FIG. 11 illustrates a flow chart for an example embodiment of the MMSE-IRC with SIC MIMO equalizer according to some examples.

FIG. 12 illustrates a flow chart for an example embodiment of the matrix-extension based MMSE-SIC with IRC MIMO equalizer according to some examples.

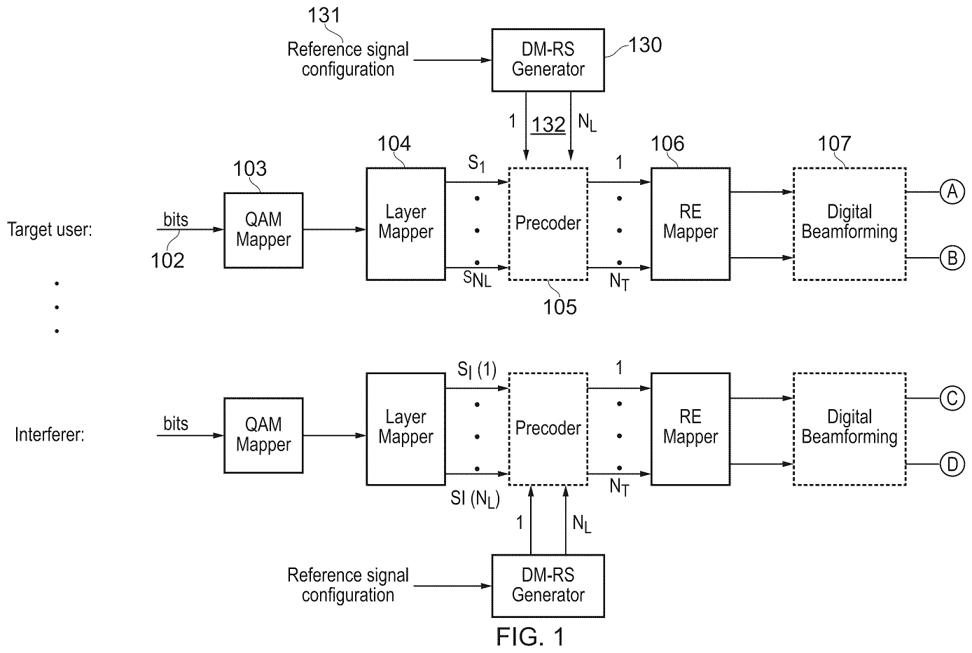

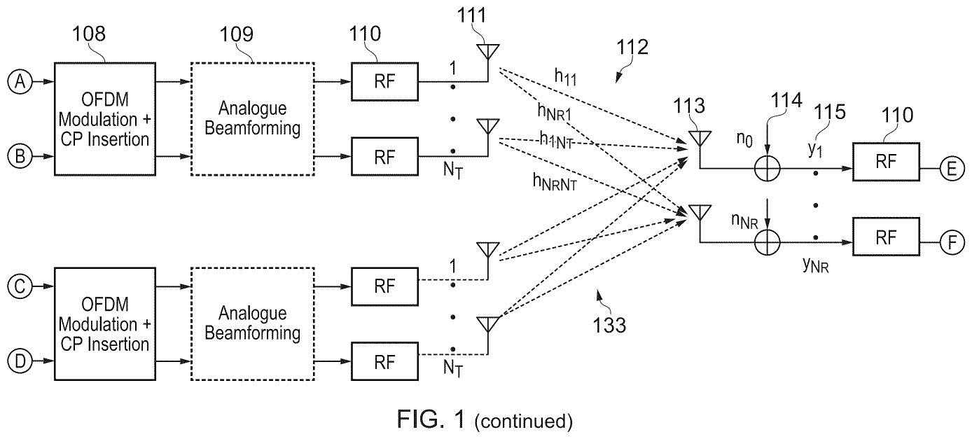

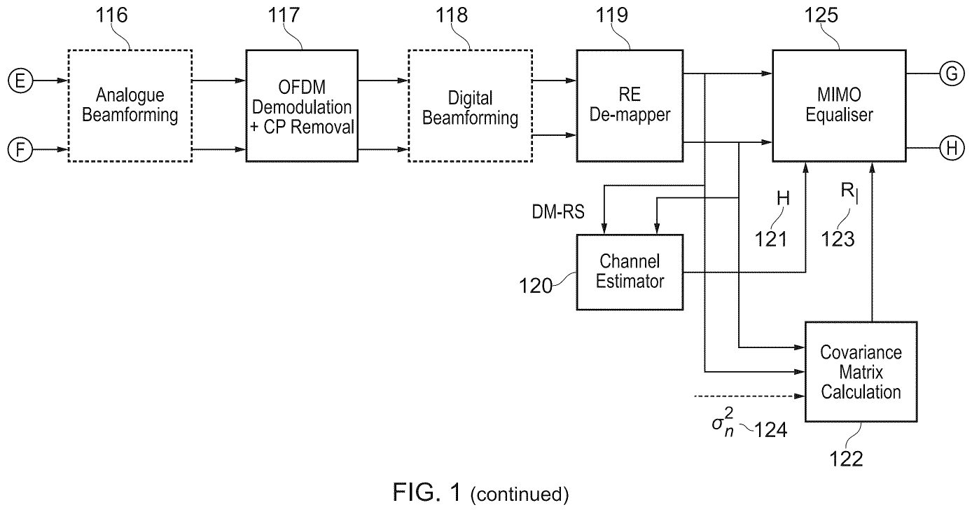

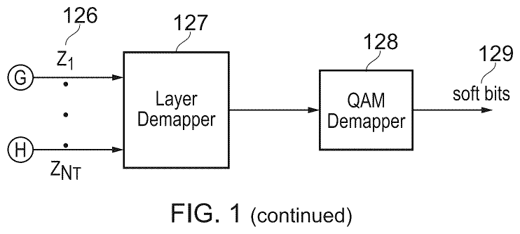

### DETAILED DESCRIPTION

As discussed above, an MMSE-IRC equalizer can be used to separate a desired user's signal from interference and noise. Other techniques have been proposed for this purpose, including non-linear equalizers, such as the maximum likelihood equalizer [4]. In a comparison between an MMSE-IRC equalizer and a non-linear equalizer, the MMSE-IRC equalizer has the advantage of low complexity and of not requiring channel estimates for the interfering users, but has the disadvantage of limited spectral efficiency, particularly when the number of layers equals the number of receive antenna ports. Conversely, the non-linear equalizer has the disadvantage of high complexity and of requiring channel estimates for the interfering users, but has the advantage of improved spectral efficiency, particularly when the number of layers equals the number of receive antenna ports. A problem exists of how to achieve the best of both worlds, to design an equalizer with all of these advantages and none of these disadvantages, namely a low complexity without the requirement of having channel estimates for the interfering users, while maintaining both high spectral efficiency when the number of layers equals the number of receive antenna ports.

Examples herein described aim to address this problem by modifying an MMSE-IRC equalizer so that it supports an interface with a non-linear equalizer, which performs SIC. The proposed solution adopts algorithms that are suited to hardware implementation, enabling high throughputs to be achieved in a cost-efficient manner.

An MMSE-IRC with SIC MIMO Equalizer Implementation

In some examples, the inventors have proposed a MMSE-IRC with SIC equalizer that may be used to meet and exceed the detection reliability of the known MMSE-IRC criterion, which specifies the requirements for a linear combining technique that relies on multiple receive antenna ports and estimates of the interfering channels to project the received signals on a subspace in which the mean square error is minimized.

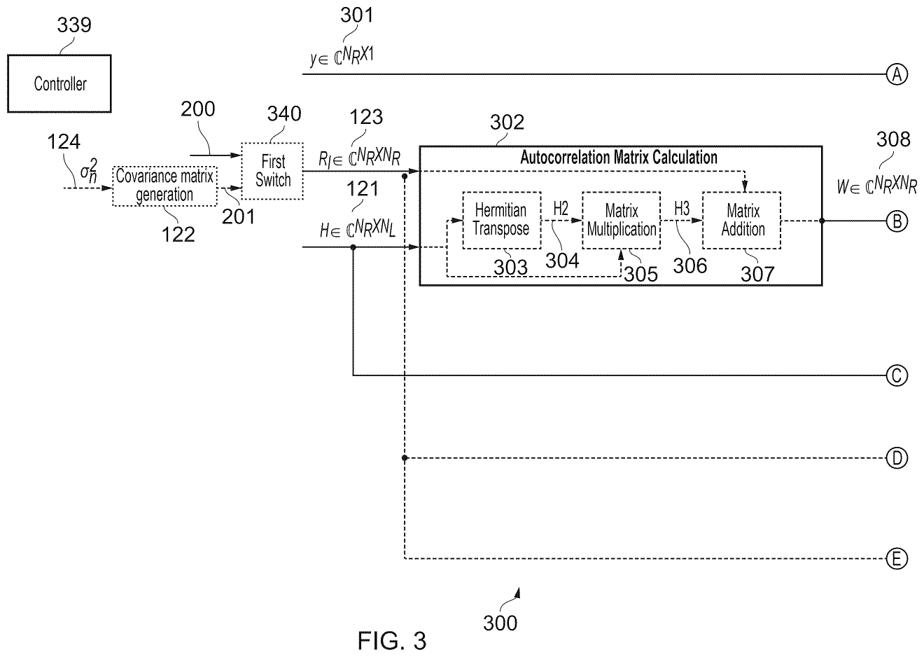

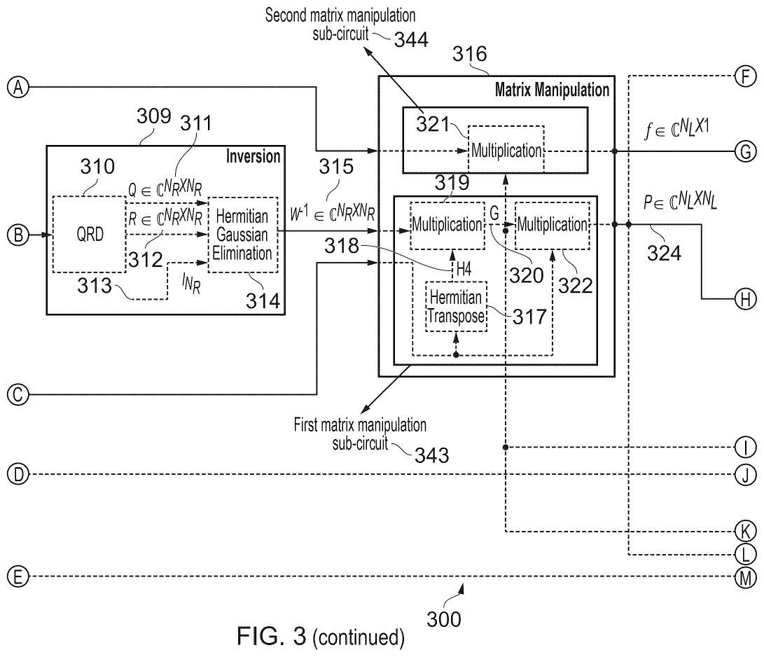

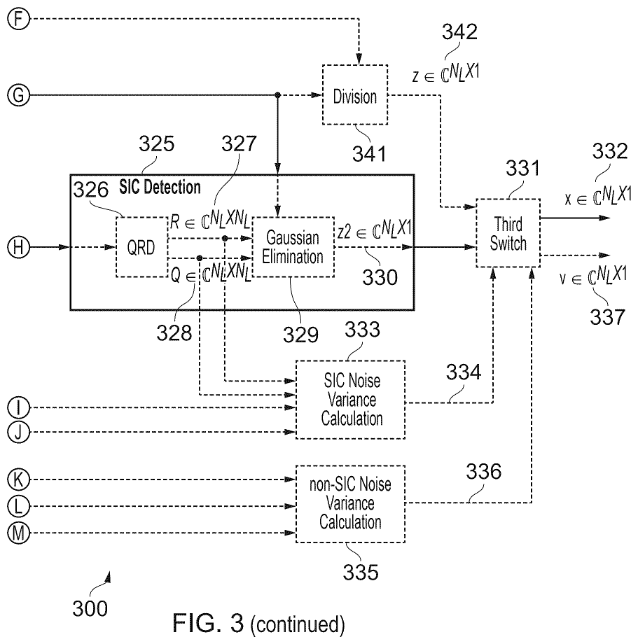

In the following discussions, the basic principles and operations for the MMSE-IRC with SIC equalizer implementation based on FIG. 3 will be discussed, followed by discussions on specific functional blocks. Finally, an example simulation result will be presented. For the sake of simplicity, the subscript ‘_IRC’ is removed from all notations in the following discussions.

Explicitly, substituting Equation (7) into Equation (8), yields:

$$\begin{matrix}f = {H}^{H} {( H {H}^{H} + {R}_{I} )}^{- 1} H s + {{H}^{H} ( H {H}^{H} + {R}_{I} )}^{- 1} ( {H}_{I} {s}_{I} + n ) \\ = {H}^{H} {W}^{- 1} H s + {H}^{H} {W}^{- 1} ( {H}_{I} {s}_{I} + n )\end{matrix} , \qquad ( 9 )$$

where the equalization gain matrix may be defined as:

$$P = {{H}^{H} ( H {H}^{H} + {R}_{I} )}^{- 1} H = {H}^{H} {W}^{- 1} H . \qquad ( 10 )$$

More specifically, in Equation (9), W=HH^{H}+R_{I} denotes the autocorrelation matrix W 308 of the received signal vector y 301 in Equation (5), where the multiplication of channel estimate matrix H 121 and its Hermitian transposed H2 matrix 304 results in a Hermitian H3 matrix 306, and the covariance matrix R_{I} 123 is also Hermitian according to the calculations in Equation (7b) and (7c), which makes the autocorrelation matrix W 308 is Hermitian. The special Hermitian structure of the W matrix may be used to simplify the implementation of the matrix inversion circuit 309 shown in FIG. 3 and the details will be discussed later.

In accordance with some examples, the successive interference cancellation, SIC, detection circuit 325 operating under the direction of the controller 339 and based on the QR decomposition, QRD, circuit 326 may be used to meet and exceed the detection reliability of the known MMSE-IRC criterion based on Equation (7), although a skilled practitioner would recognise that other means of implementing SIC detection could also be employed. For example, the conventional MMSE criterion based SIC detection, which uses several iterations for implementing the layer-by-layer interference cancellation and requires the re-calculation of the filter matrix in each iteration, could be used for achieving a more reliable detection at the cost of higher latency, higher power consumption and higher hardware complexity. More explicitly, the P matrix 324 is first factorized based on the QR decomposition, yielding P=QR and hence the f vector 323 in Equation (9) can be expressed as:

$$f = Q R s + G ( {H}_{I} {s}_{I} + n ) , \qquad ( 11 )$$

where the orthogonal unitary matrix Q 328 has orthogonal columns with unit norm and the upper triangular matrix R 327 is upper triangular. Multiplying the f vector 323 with Q^{H} yields sufficient statistic

$$f 1 = {Q}^{H} f = R s + {Q}^{H} G ( {H}_{I} {s}_{I} + n ) = R s + {G}_{2} ( {H}_{I} {s}_{I} + n ) , \qquad ( 12 )$$

for the estimation of the transmitted vector s, where G₂=Q^{H}G.

Let the upper triangular matrix R 327 in Equation (12) be expressed as

$$R = [ \begin{matrix}{r}_{11} & … & {r}_{1 {N}_{L}} \\ ⋮ & ⋱ & ⋮ \\ 0 & … & {r}_{{N}_{L} {N}_{L}}\end{matrix} ] \qquad ( 13 )$$

The first term on the right-hand side of the Equation (12) contains both the expected signal and the interference from the detected symbols and constructs the SIC architecture for introducing successive interference cancellation by the Gaussian elimination circuit. Then, the overall process for implementing the Gaussian elimination circuit 329 can be directed by the controller 339 and represented as the following pseudo code:

### Algorithm-1

Input: orthogonal unitary matrix Q 328, upper triangular matrix R 327, f vector 323
Output: Z2 vector 330 and the noise variance vector v 337

### Step 1—Formulation

Let us assume the detection order is [N_{L}, . . . , 1]. In general, the i-th filtered symbol f1(i) (i=N_{L}, . . . , 1) in Equation (12) can be given by:

$$f 1 ( i ) = {R}_{i i} {s}_{i} + {\sum }_{j = 1 + 1}^{{N}_{L}} {R}_{ij} + {r}_{i} \qquad ( 14 )$$

where (.)ii denotes the element at the i-th row and the i-th column of a matrix, ri represents the remaining interference plus noise at the i-th detection layer.

The first component on the right-hand side of Equation (14) contains the expected signal, the second component on the right-hand side contains the interference from the detected symbols which will be successively cancelled by the Gaussian elimination circuit, the third component reveals the remaining filtered interference plus noise at the i-th detection layer. For the sake of analysis, according to Equation (14), the equalized gain at the i-th detection layer can be expressed as

$${μ}_{i} = {R}_{ii} \qquad ( 15 )$$

Then, the Equation (14) can be re-expressed as:

$$f 1 ( i ) = {μ}_{i} {s}_{i} + {\sum }_{j = 1 + 1}^{{N}_{L}} {R}_{ij} {s}_{j} + {r}_{i} \qquad ( 16 )$$

### Step 2—Initialization

According to the general expression in Equation (14)-(16), at the first detection layer where i=N_{L}, the first equalized symbol z2(i) and the noise variance vᵢ may be expressed as:

$$z 2 ( {N}_{L} ) = \frac{{f}_{1} ( {N}_{L} )}{{μ}_{{N}_{L}}} \qquad ( 17 )$$

$${v}_{{N}_{L}} = \frac{{G}_{2} ( {N}_{L} , : ) {R}_{1} {{G}_{2} ( {N}_{L} , : )}^{H}}{{\vert {μ}_{{N}_{L}} \vert}^{2}} \qquad ( 18 )$$

where G₂(i,:) represents the i-th row vector of the G₂ matrix in Equation (12).

### Step 3—Gaussian Elimination

$$for$$

$$i = {N}_{L} , … , 1$$

$${d}_{i} = {\sum }_{j = i + 1}^{{N}_{L}} {R}_{i , j} {s}_{j} \qquad ( 19 )$$

$$z 2 ( i ) = Quant ( \frac{{f}_{1} ( i ) - {d}_{i}}{{μ}_{i}} ) \qquad ( 20 )$$

$${v}_{i} = \frac{( 1 - {\vert {( {Q}_{2} )}_{ii} \vert}^{2} )}{{\vert {μ}_{i} \vert}^{2}} \qquad ( 21 )$$

$$end$$

where: dᵢ in Equation (19) corresponds to the second term on the right-hand side of Equation (16), and at the first detection layer shown in the algorithm where i=Nᵢ, yields dᵢ=0.

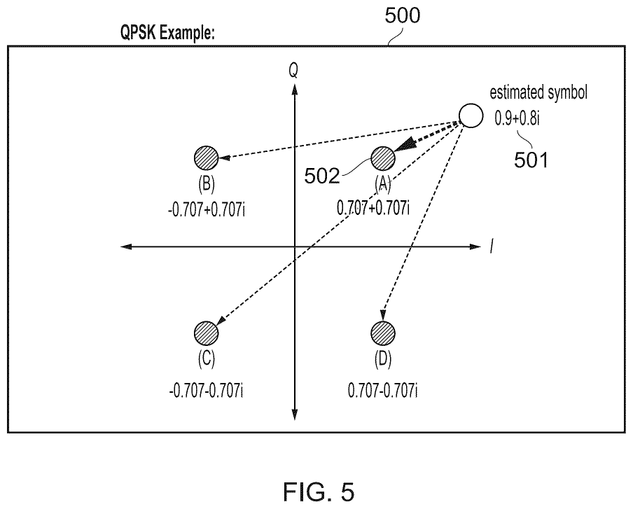

Furthermore, the Quant(.) as shown in Equation (20) reveals the operation of quantization, where the quantization is used to find the nearest QAM constellation point with the equalized symbol for further improving the detection reliability at the cost of a higher circuit power consumption and a higher latency. Here, a selection between different QAM constellation schemes such as BPSK, QPSK, 16QAM, 64QAM and 256QAM may be adopted at run-time, depending on the scheme adopted in the transmitter. For example, in a QPSK constellation scheme as illustrated in FIG. 5, an estimated received symbol 501 has the complex value of 0.9+0.8i. The operation Quant(.) of quantization is used to find the nearest constellation point with the estimated symbol, where constellation point A 502 positioned at 0.707+0.707i is the nearest point with the estimated symbol as seen in FIG. and hence 0.707+0.707i is the output of Quant(.) in Equation (20) in this example.

After introducing the basic principles and operations illustrated in FIG. 3 for the proposed MMSE-IRC with IRC equalizer, some functional blocks will be explicitly discussed in the following context.

Specifically, the noise variance vector calculated in Equation (21) corresponds to the output of the optional SIC noise variance calculation circuit 333 illustrated in FIG. 3, and the output of the optional non-SIC noise variance calculation circuit 335 illustrated in FIG. 3 can be calculated based on Equation (8f). The decision for whether or not to enable SIC could be controlled at run-time in a practical system according to the channel SINR, where it may be preferable to disable SIC when the SINR is below a particular threshold and preferable to enable it when the SINR is above the threshold. A skilled practitioner would recognise that other features such as channel gains or covariance matrix properties could be used to control the decision.

In accordance with some examples described herein, a MIMO equalizer circuit 300 as illustrated in FIG. 3 comprising a controller 339, an autocorrelation matrix calculation circuit 302, a matrix inversion circuit 309, a matrix manipulation circuit 316, and a SIC detection circuit 325 may be used to convert a first input which is provided by a received signal vector y 301 of dimension (N_{R}×1), a second input which is provided by a channel estimate matrix H 121 of dimension (N_{R}×N_{L}) and a third input which is provided by a covariance matrix R_{I} 123 of dimension (N_{R}×N_{R}) into an output which provides an equalized signal vector x 332 of dimension (N_{L}×1), wherein multiple values are supported for the size N_{R} and for the size N_{L}. A skilled practitioner would recognise that the dimensions of all matrices could be swapped, such that rows become columns and vice versa. A skilled practitioner would readily recognise that some reordering of terms in the matrix expressions would be required but would give identical operation to that described in this discussion.

More explicitly, the autocorrelation matrix calculation circuit 302 operated under the direction of the controller 339 as illustrated in FIG. 3 and further comprising a Hermitian transpose circuit 303, a matrix multiplication circuit 305, and a matrix addition circuit 307 may be used to produce the autocorrelation matrix W 308.

Furthermore, the matrix manipulation circuit 316 operates under the direction of the controller 339 as illustrated in FIG. 3 and further comprising a pair of sub-circuits, wherein the first matrix manipulation sub-circuit 343 comprises a Hermitian transpose circuit 317, a first multiplication circuit 319, and a second multiplication circuit 322, and the second matrix manipulation sub-circuit 344 comprises a multiplication circuit 321, may be used to produce the P matrix 324 and the f vector 323.

More specifically, in order to reduce the implementation complexity of the autocorrelation matrix inversion involved in the calculation of the G matrix 320 in Equation (7), a QRD with Hermitian Gaussian elimination-based matrix inversion circuit 309 may be used in the MIMO equalizer circuit 300 illustrated in FIG. 3. Explicitly, in the MIMO equalizer circuit 300 where the matrix inversion circuit 309 operates under the direction of the controller 339, as shown in FIG. 3, and comprises a QRD circuit 310 and a Hermitian Gaussian elimination circuit 314, where the QRD circuit may be used to convert the autocorrelation matrix W 308 into an orthogonal unitary matrix Q 311 of dimension (N_{R}×N_{R}) and an upper triangular matrix R 312 of dimension (N_{R}×N_{R}), and the Hermitian Gaussian elimination circuit 314 may be used to convert the orthogonal unitary matrix Q 311, the upper triangular matrix R 312, and an identity matrix I 313 of dimension (N_{R}×N_{R}) into the inverted autocorrelation matrix 315. For the sake of a simplified analysis, the overall process of using QRD with Hermitian Gaussian elimination-based matrix inversion can be described as the following pseudo code:

### Algorithm-2

Input: Autocorrelation matrix W 308
Output: Inverted autocorrelation matrix 315 T=W⁻¹

### Step 1: Problem Formulation

If autocorrelation matrix W 308 of dimension (N_{R}×N_{R}) is invertible and T=W⁻¹, the following relationship may exist:

$$W {W}^{- 1} = I \qquad ( 22 )$$

### Step 2: QR Decomposition on W Matrix

From QR decomposition:

$$Q RT = I \qquad ( 23 )$$

By applying Q^{H} on Equation (23), yields:

$$R T = {Q}^{H} \qquad ( 24 )$$

### Step 3: Hermitian Gaussian Elimination

Benefiting from the upper triangular structure of the upper triangular matrix R 312 and from the Hermitian structure of autocorrelation matrix W 308 as discussed earlier, T matrix can be calculated by using a Hermitian Gaussian elimination, wherein the Hermitian Gaussian elimination can be described as

$$for$$

$$i = 1 , … , {N}_{R}$$

$$for$$

$$k = {N}_{R} , … , i$$

$${d}_{k} = {\sum }_{j = k + 1}^{{N}_{R}} {r}_{k , j} T ( j , i ) \qquad ( 25 )$$

$$T ( k , i ) = \frac{{Q}^{H} ( k , i ) - {d}_{k}}{{r}_{k , k}} \qquad ( 26 )$$

$$end$$

$$end$$

where (0.5N_{R}²+0.5N_{R}) number of operations executed by Equation (25) and (26) is required by the Hermitian Gaussian elimination shown in the pseudo code. However, in a conventional Gaussian elimination in a matrix inversion circuit as described in the following pseudo code, N_{R}² number of operations is required.

### Conventional Gaussian Elimination:

$$for$$

$$i = 1 , … , {N}_{R}$$

$$for$$

$$k = {N}_{R} , … , 1$$

$${d}_{k} = {\sum }_{j = k + 1}^{{N}_{R}} {r}_{k , j} T ( j , i ) \qquad ( 27 )$$

$$T ( k , i ) = \frac{{Q}^{H} ( k , i ) - {d}_{k}}{{r}_{k , k}} \qquad ( 28 )$$

$$end$$

$$end$$

More specifically, W or T matrix always have the Hermitian property and an example of the Hermitian T matrix of dimension (3×3) can be expressed as

$$T = [ \begin{matrix}{t}_{1 , 1} & {t}_{2 , 1}^{*} & {t}_{3 , 1}^{*} \\ {t}_{2 , 1} & {t}_{2 , 2} & {t}_{3 , 2}^{*} \\ {t}_{3 , 1} & {t}_{3 , 2} & {t}_{3 , 3}\end{matrix} ] . \qquad ( 29 )$$

From the Hermitian structure shown in Equation (29), calculating the lower triangular elements of the inverted autocorrelation matrix 315 which in this case is matrix T is enough for obtaining the full matrix, where the upper off-diagonal elements can be obtained by calculating the Hermitian of the lower off-diagonal elements. Note that in some examples herein described, it may always use the lower-complexity Hermitian Gaussian elimination in the matrix inversion circuit. A skilled practitioner would recognise that a conventional Gaussian elimination can be used in place of the Hermitian Gaussian elimination, at the cost of higher latency, higher power consumption and/or hardware complexity.

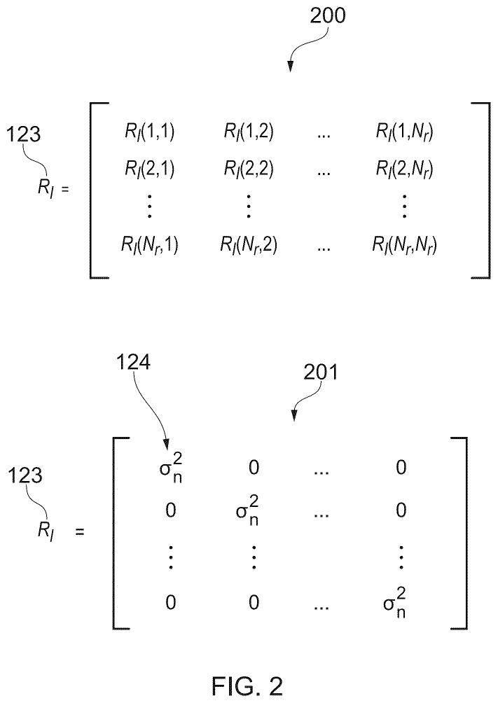

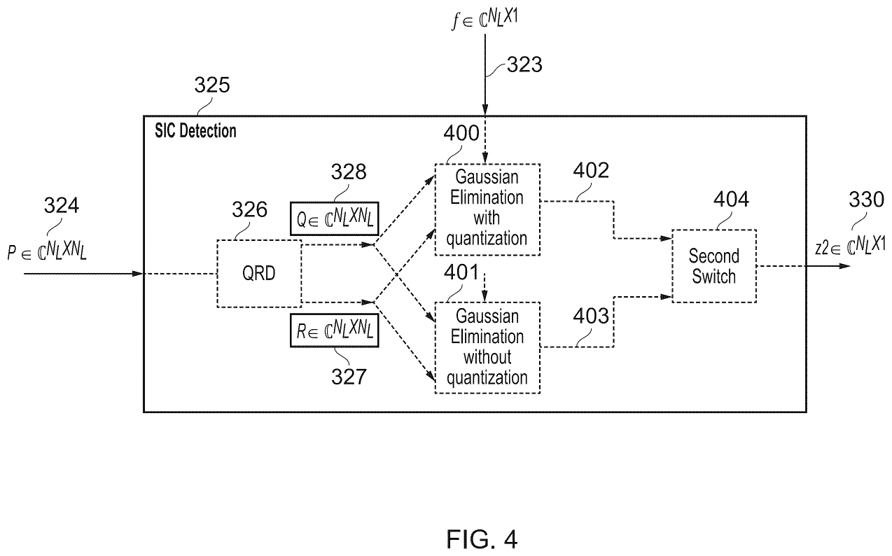

In accordance with some examples described herein, three switches may be optionally applied in the MIMO equalizer circuit 300 as illustrated in FIG. 3, FIG. 4, wherein each switch supports two modes of operation under the direction of the controller 339 and eight combinations of the run-time modes of operation can be supported by the four switches. More explicitly, as shown in FIG. 3, the first switch 340 supports a first mode of operation wherein the covariance matrix input 200 which in this case contains both interference and noise as shown in the left-hand side example in FIG. 2 is used for equalisation following the MMSE-IRC criterion and wherein the first switch 340 optionally supports a second mode of operation wherein the diagonal covariance matrix 201 as shown in the right-hand side example in FIG. 2 is generated from the fourth input of noise power scalar 124 and used for equalisation following the MMSE criterion under the direction of the controller 339. The fourth input of noise power scalar 124 is optional and a covariance matrix generation circuit 122 as shown in FIG. 3 is required for calculating a diagonal covariance matrix 201 as seen in the right-hand side covariance matrix example in FIG. 2.

Furthermore, the second switch in FIG. 4 supports a third mode of operation wherein the Gaussian elimination with quantization circuit 400 as described in the pseudo code of Algorithm-1 is used, and the second switch 404 optionally supports a fourth mode of operation wherein the Gaussian elimination without quantization circuit 401 is used under the direction of the controller 339 wherein the Quant(f1(i)−dᵢ/μᵢ) function in Algorithm-1 is replaced with (f1(i)−dᵢ)/μᵢ in Equation (20). The quantization operation is used to find the nearest QAM constellation point with the equalized symbol for further improving the detection reliability at the cost of a higher power consumption and a higher latency. The quantization operation may be switched off when a lower power consumption and lower latency circuit is required. Furthermore, the decision for whether or not to enable quantisation could be controlled at run-time in a practical system according to the channel SINR, where it may be preferable to disable quantisation when the SINR is below a particular threshold and preferable to enable it when the SINR is above the threshold. A skilled practitioner would recognise that other features such as channel gains or covariance matrix properties could be used to control the decision. Note that in a practical implementation, the Gaussian elimination with quantisation circuit 400 and the Gaussian elimination without quantisation circuit 401 could be implemented separately, together with a physical implementation of the second switch 404. Alternatively, a skilled practitioner would recognise that the hardware complexity could be reduced by reusing circuitry between the Gaussian elimination with quantisation circuit 400 and the Gaussian elimination without quantisation circuit 401, with the second switch 404 being merged into the controller 339 for the resultant circuit.

Then, the third switch 331 as illustrated in FIG. 3 supports a fifth mode of operation under the direction of the controller 339, wherein the z vector 342 which is illustrated in FIG. 3 and expressed in Equation (8e) is operably coupled to the equalized signal vector x 332 and the MMSE-IRC criterion is switched on, and the third switch 331 optionally supports a sixth mode of operation, wherein the Z2 vector 330 which is illustrated in FIG. 3 and expressed in Equation (20) in Algorithm-1 is operably coupled to the equalized signal vector x 332 and our MMSE-IRC with SIC equalizer is switched on. Explicitly, the f vector 323 in Equation (9) may be divided by the equalisation gain scalar expressed in Equation (8c) by using a division circuit 341 and then the estimated symbol vector z 342 as expressed in Equation (8e) is obtained. For example, the fifth mode of operation may be operably supported by the third switch 331 when the channel SINR value is below a threshold value and the sixth mode of operation may be optionally supported when the channel SINR value is above the threshold value. Note that the decision of when to support the fifth and the sixth modes of operations is just an example and that a skilled practitioner would recognise that other features such as channel gains or covariance matrix properties could be used to control the decision.

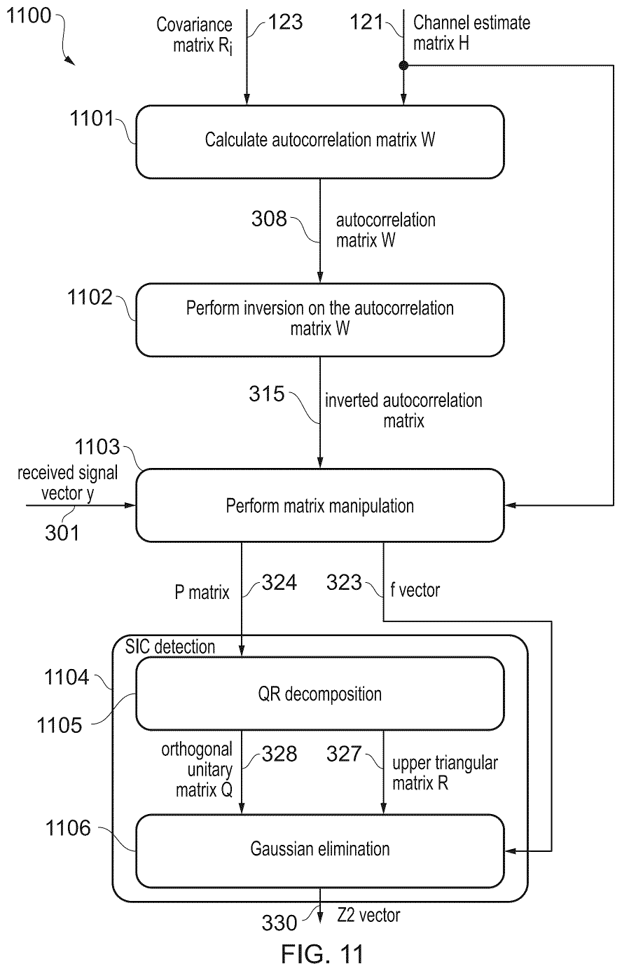

In summary, a particular manifestation of an example for MIMO equalisation may be described by the flowchart 1100 of FIG. 11. The operation begins at 1101, where autocorrelation matrix W 308 is calculated as a function of a covariance matrix R_{I} 123 and a channel estimate matrix H 121. Following this, the autocorrelation matrix W 308 is inverted at 1102, in order to generate an inverted autocorrelation matrix 315. The inverted autocorrelation matrix 315, a received signal vector y 301, and the channel estimate matrix H 121 are manipulated at 1103, in order to generate a P matrix 324 and a f vector 323. Following this, a SIC detection is performed at 1104, which converts the P matrix 324 and the f vector 323 into a z2 vector 330. To elaborate further, SIC detection 1104 comprises a first step 1105, in which a QR decomposition is applied to the P matrix 324 in order to obtain an orthogonal unitary matrix Q 328 and an upper triangular matrix R 327. Following this, SIC detection 1104 is concluded by a second step 1106, in which Gaussian elimination is performed in order to convert the f vector 323, the orthogonal unitary matrix Q 328 and the upper triangular matrix R 327 into the z2 vector 330.

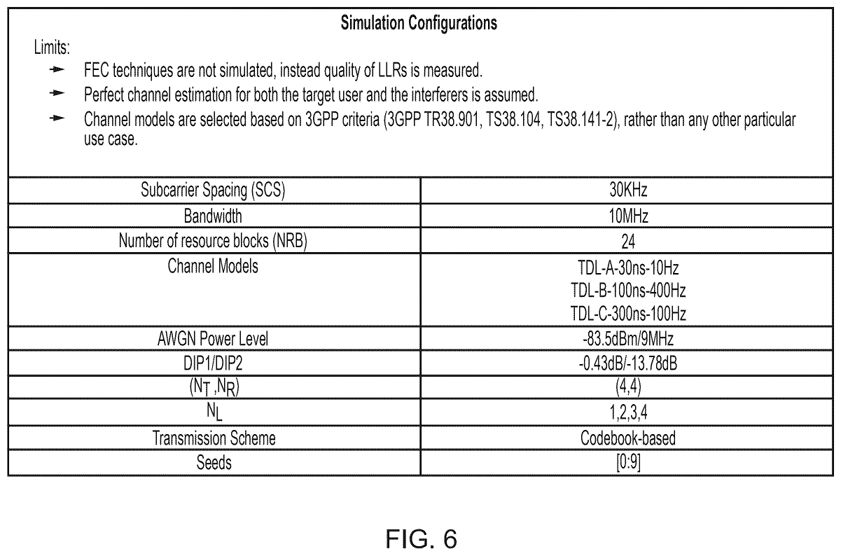

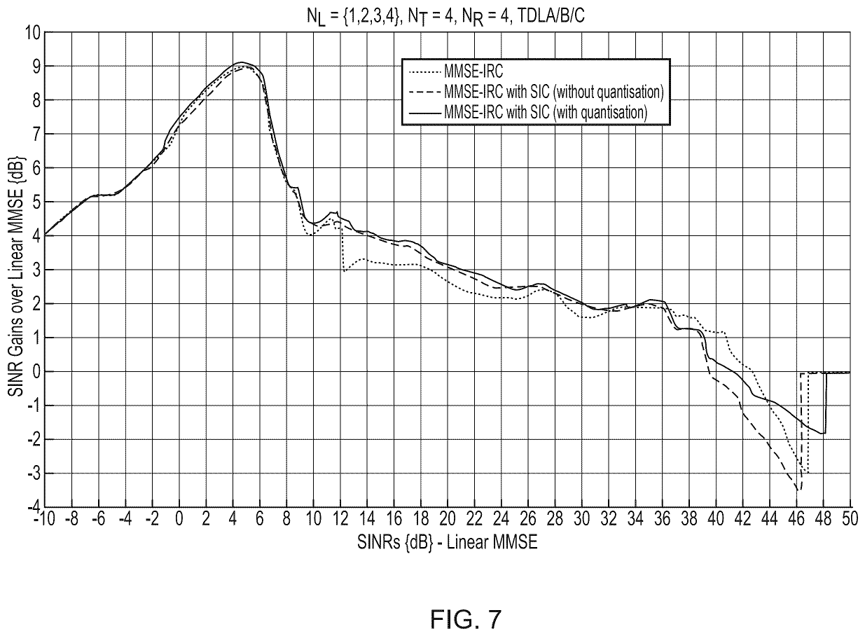

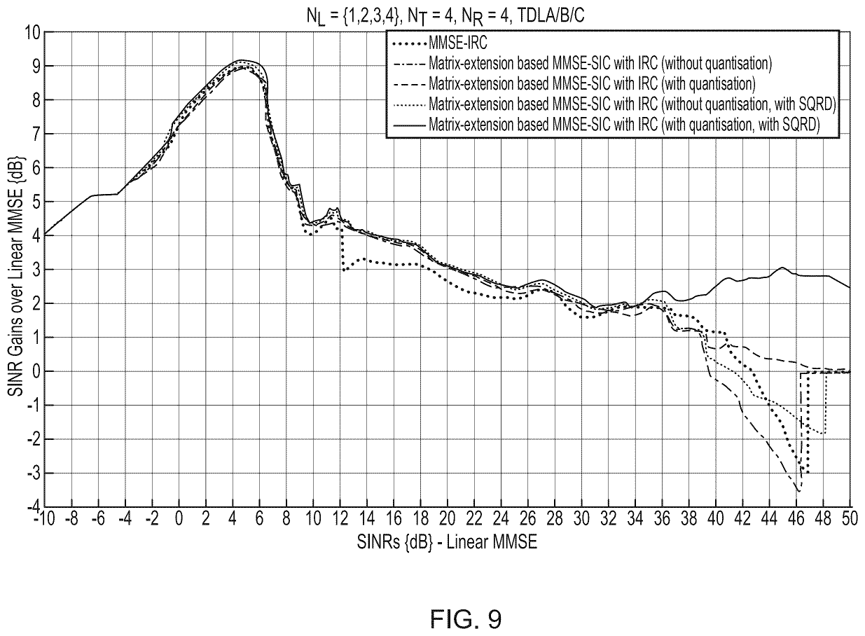

In accordance with some examples described herein, FIG. 7 presents an example simulation result based on the simulation configurations shown in FIG. 6 for the MMSE-IRC with SIC MIMO equalizer, where the SINR gain over the linear MMSE criterion vs. SINR is presented. Explicitly, as shown in FIG. 9, based on our initial simulations based on the 3GPP standard scenarios, the MMSE-IRC criterion has been demonstrated to have about 3 dB SINR gains over the linear MMSE criterion across a wide range of SINRs. In particular, the SINR gains are over 3 dB and even nearly up to 8.9 dB over the linear MMSE criterion in the low SINR region. Furthermore, the proposed MMSE-IRC with SIC MIMO equalizer has been able to provide about up to 1.0 dB further SINR gains over MMSE-IRC criterion at medium SINR region.

a Matrix-Extension Based MMSE-SIC with IRC MIMO Equalizer Implementation

In some examples, the inventors have proposed a matrix-extension based MMSE-SIC with IRC equalizer that may be used to meet and exceed the detection of the known MMSE-IRC criterion, which specifies the requirements for a linear combining technique that relies on multiple receive antenna ports and estimates of the interfering channels to project the received signals on a subspace in which the mean square error is minimized. In some examples, the proposed matrix-extension based MMSE-SIC equalizer, may utilize a QR decomposition or a sorted QR decomposition of the extended channel matrix and leads to a successive detection structure, where specifically a sorted QR decomposition of an extended channel matrix may be used to calculate an optimized detection order for the SIC architecture.

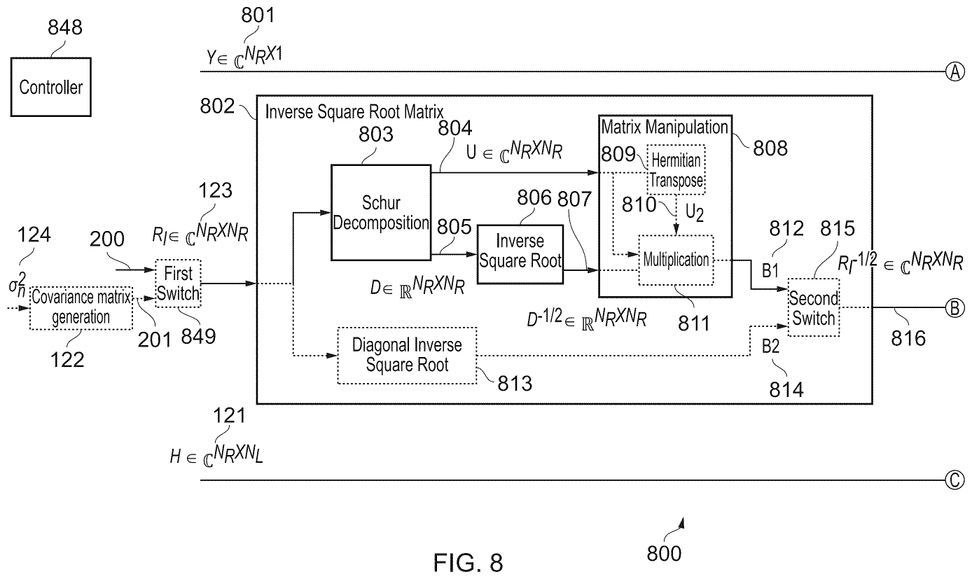

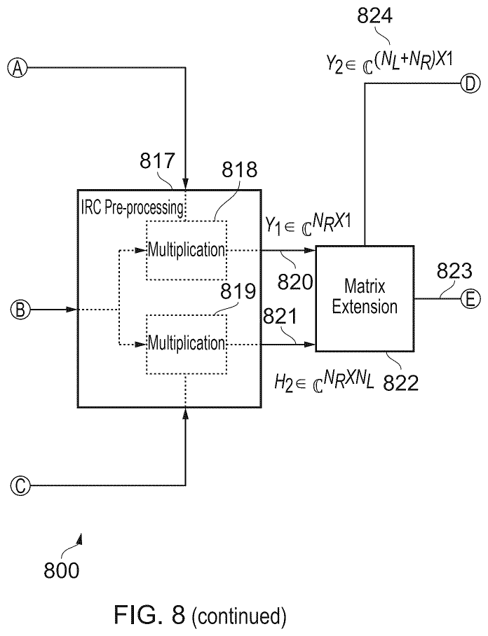

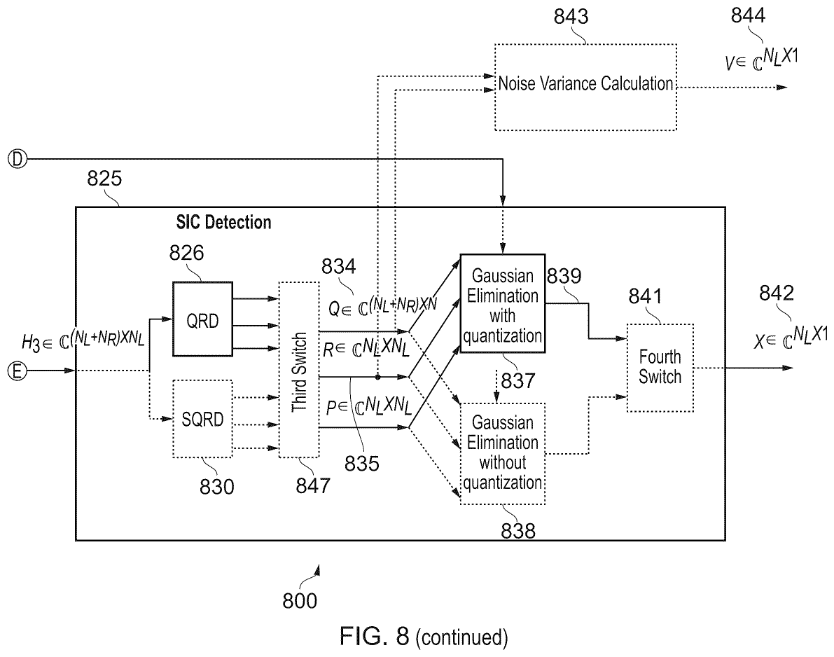

In the following discussions, the basic principles and operations for the MIMO matrix-extension based MMSE-SIC with IRC equalizer circuit 800 based on FIG. 8 will be discussed, followed by discussions on specific functional blocks. Finally, an example simulation result will be presented. For the sake of simplicity, the subscript _IRC is removed from all notations in the following discussions.

In accordance with some examples described herein, a matrix-extension based MMSE-SIC MIMO equalizer circuit 800 as illustrated in FIG. 8 comprising controller 848, an inverse square root matrix circuit 802, an IRC pre-processing circuit 817, a matrix extension circuit 822, and a SIC detection circuit 825 may be used to convert a first input which is provided by a received signal vector y 801 of dimension (N_{R}×1), a second input which is provided by a channel estimate matrix H 121 of dimension (N_{R}×N_{L}) and a third input which is provided by a covariance matrix R_{I} 123 of dimension (N_{R}×N_{R}) into an output which provides an equalized signal vector x 842 of dimension (N_{L}×1), wherein multiple values are supported for the size N_{R} and for the size N_{L}.

A skilled practitioner would recognise that the dimensions of all matrices could be swapped, such that rows become columns and vice versa. A skilled practitioner would readily recognise that some reordering of terms in the matrix expressions would be required but would give identical operation to that described in this discussion.

More specifically, the MMSE-IRC criterion minimizes the mean square error between the actually transmitted symbols and the equalized symbols output and leads to the filter matrix G as expressed in Equation (7). Then, by using the matrix inverse lemma, the filter matrix in Equation (7) can also be expressed as:

$$G = {( {H}^{H} {R}_{I}^{- 1} H + {I}_{{N}_{L}} )}^{- 1} {H}^{H} {R}_{I}^{- 1} , \qquad ( 30 )$$

where R_{I}⁻¹ denotes the inverse of the covariance matrix of the interference plus noise and I_{NL} is an identity matrix of dimension (N_{L}×N_{L}).

From Equation (30), the extended preprocessed channel estimate H₃ matrix 823 and the extended preprocessed received signal y2 vector 824 can be obtained by a matrix extension circuit 822 and may be defined as:

$${H}_{3} = [ \begin{matrix}{R}_{I}^{- 1 / 2} H \\ {I}_{{N}_{L}}\end{matrix} ] , \qquad ( 31 )$$

$${y}_{2} = [ \begin{matrix}{R}_{I}^{- 1 / 2} y \\ 0\end{matrix} ] , \qquad ( 32 )$$

where the inverted square root matrix R_{If}^{-1/2} 816 is the inverse of square root covariance matrix and is calculated by the inverse square root matrix circuit 802 as shown in FIG. 8, y is the received signal vector y 801 shown in Equation (5), the preprocessed channel estimate H2 matrix 821 expressed as H2=R_{I}^{-1/2}H can be obtained with the aid of a third multiplication circuit 819, and the preprocessed received signal y1 vector 820 being expressed as y1=R_{I}^{-1/2}y can be obtained with the aid of a second multiplication circuit 818, as illustrated in the IRC pre-processing circuit 817 in FIG. 8.

In accordance with some examples, the inverse of square root covariance matrix can be calculated with the aid of the Schur decomposition circuit 803 as illustrated in FIG. 8 which performs Schur decomposition. Explicitly, the Schur decomposition of the covariance matrix R_{I} can be expressed as:

$${R}_{I} = {UDU}^{H} , \qquad ( 33 )$$

where the orthogonal eigenvectors matrix U 804 is an orthogonal unitary matrix of dimension (N_{R}×N_{R}) wherein the N_{R} column vectors represent N_{R} orthogonal eigenvectors of the covariance matrix, the Hermitian transposed U2 matrix 810 being expressed as U2=U^{H} is the Hermitian transpose of U matrix which can be obtained with the aid of a Hermitian transpose circuit 809 as illustrated in FIG. 8. Specifically, the real-valued diagonal matrix D 805 of dimension (N_{R}×N_{R}) has real-valued diagonal elements and the diagonal elements are eigenvalues of the covariance matrix.

Then, according to Equation (33), the B1 matrix 812 as illustrated in FIG. 8 being expressed as B1=R_{I}^{-1/2} can be calculated as:

$${R}_{I}^{- 1 / 2} = U {D}^{- 1 / 2} {U}^{H} , \qquad ( 34 )$$

by using the matrix manipulation circuit 808 as shown in FIG. 8, where B1 matrix 812 can be obtained by a multiplication circuit 811, and the inverted square root real-valued diagonal matrix D^{-1/2} 807 obtained by an inverse square root circuit 806 only requires individual scalar inverse square root operations of the individual real-valued diagonal elements in the real-valued diagonal matrix D 805.

In accordance with some examples, the SIC detection circuit 825 based on QR decomposition may be used, although a skilled practitioner would recognise that other means of implementing SIC detection could also be employed. For example, the conventional MMSE criterion based SIC detection, which uses several iterations for implementing the layer-by-layer interference cancellation and requires the re-calculation of the filter matrix in each iteration, could be used for achieving a more reliable detection at the cost of higher latency, higher power consumption and higher hardware complexity. More explicitly, the extended channel H₃ matrix is first factorized based on the QR decomposition, QRD, circuit 826, yielding:

$$\begin{matrix}{H}_{3} = QR & ( 35 ) \\ = [ \begin{matrix}{Q}_{1} \\ {Q}_{2}\end{matrix} ] R , & ( 36 )\end{matrix}$$

where in this example the orthogonal unitary matrix Q 834 that happens to have orthogonal columns is partitioned into the (N_{R}×N_{L}) matrix Q₁ and the (N_{L}×N_{L}) matrix Q₂, and the upper triangular matrix R 835 is upper triangular.

According to Equation (35) and (36), the relation between Q₁ and Q₂ can be described as

$${Q}^{H} {H}_{3} = [ {Q}_{1}^{H} {Q}_{2}^{H} ] [ \begin{matrix}{R}_{I}^{- 1 / 2} H \\ {I}_{{N}_{L}}\end{matrix} ] = {Q}_{1}^{H} {R}_{I}^{- 1 / 2} H + {Q}_{2}^{H} = R , \qquad ( 37 )$$

Using the relation shown in Equation (37), multiplying the extended preprocessed received signal vector y₂ 824 with Q^{H} yields the statistic as:

$${y}_{3} = {Q}^{H} {y}_{2} = Rs - {Q}_{2}^{H} s + {Q}_{1}^{H} {R}_{I}^{- 1 / 2} ( {H}_{I} {s}_{I} + n ) . \qquad ( 38 )$$

The first term on the right-hand side of Equation (38) including the upper triangular matrix R 835 shows the interference from the detected symbols and constructs the SIC architecture for introducing successive interference cancellation, the second term on the right-hand side of the equation including the lower triangular matrix Q₂^{H} constitutes the interference from the undetected symbols, and the third term reveals the remaining interference plus noise, where the expected signal is contained in the first and second terms.

Then, the overall process for implementing the SIC detection based on Equation (38) can be represented as the following pseudo code:

### Algorithm-3

Input: Orthogonal unitary matrix Q 834, upper triangular matrix R 835, v₃ vector
Output: Equalized signal vector x 842, noise variance vector v 844

### Step 1—Formulation

Suppose the detection order is given as [N_{L}, . . . , 1]. In general, the i-th detected symbol y₃(i) (i=N_{L}, . . . , 1) can be given by:

$${y}_{3} ( i ) = ( {R}_{ii} - {( {Q}_{2}^{H} )}_{ij} ) {s}_{i} + {\sum }_{j = 1 + 1}^{{N}_{L}} {R}_{ij} {s}_{j} - {\sum }_{j = 1}^{i - 1} {( {Q}_{2}^{H} )}_{ij} {s}_{j} + {r}_{i} \qquad ( 39 )$$

where: (.)ᵢᵢ denotes the element at the i-th row and the i-th column of a matrix, rᵢ represents the remaining interference plus noise at the i-th detection layer.

The first component on the right-hand side of Equation (39) contains the expected signal, the second component on the right-hand side contains the interference from the detected symbols which will be successively cancelled by the Gaussian elimination circuit, the third component reveals the interference from the undetected symbols, and the fourth component is the remaining filtered interference plus noise.

For the sake of analysis, the third and fourth components on the right-hand side of Equation (39) can be expressed as eᵢ which is the equivalent interference plus noise at the i-th detection layer:

$${e}_{i} = - {\sum }_{j = 1}^{i - 1} {( {Q}_{2}^{H} )}_{ij} {s}_{j} + {r}_{i} \qquad ( 40 )$$

and the equalized gain at the i-th detection layer can be expressed as:

$${μ}_{i} = {R}_{ii} - {( {Q}_{2}^{H} )}_{ii} \qquad ( 41 )$$

Then the Equation (39) can be re-expressed as:

$${y}_{3} ( i ) = {μ}_{i} {s}_{i} + {\sum }_{j = 1 + 1}^{{N}_{L}} {R}_{ij} {s}_{j} + {e}_{i} \qquad ( 42 )$$

### Step 2—Initialization

According to the general expression in Equation (39)-(42), at the first detection layer where i=N_{L}, the first equalized symbol xi and the noise variance vᵢ may be defined as:

$${x}_{{N}_{L}} = \frac{{y}_{3} ( {N}_{L} )}{{μ}_{{N}_{L}}} \qquad ( 43 )$$

$${v}_{{N}_{L}} = \frac{( 1 - {\vert {( {Q}_{2} )}_{{N}_{L} , {N}_{L}} \vert}^{2} )}{{\vert {μ}_{{N}_{L}} \vert}^{2}} \qquad ( 44 )$$

### Step 3—Gaussian Elimination

$$for$$

$$i = {N}_{L} , … , 1$$

$${d}_{i} = {\sum }_{j = i + 1}^{{N}_{L}} {R}_{i , j} {s}_{j} \qquad ( 45 )$$

$${x}_{i} = Quant ( \frac{{y}_{s} ( i ) - {d}_{i}}{{μ}_{i}} ) \qquad ( 46 )$$

$${v}_{i} = \frac{( 1 - {\vert {( {Q}_{2} )}_{ii} \vert}^{2} )}{{\vert {μ}_{i} \vert}^{2}} \qquad ( 47 )$$

$$end$$

where dᵢ in Equation (45) corresponds to the second term on the right-hand side of Equation (39), and at the first detection layer shown in the algorithm where i=N_{L}, yields dᵢ=0. Furthermore, the Quant(.) as shown in Equation (46) reveals the operation of quantization, where the quantization is used to find the nearest QAM constellation point with the equalized symbol for further improving the detection reliability at the cost of a higher circuit power consumption and a higher latency. Here, a selection between different QAM constellation schemes such as BPSK, QPSK, 16QAM, 64QAM and 256QAM may be adopted at run-time, depending on the scheme adopted in the transmitter. For example, in a QPSK constellation scheme as illustrated in FIG. 5, an estimated received symbol has the complex value of 0.9+0.8i. The operation Quant(.) of quantization is used to find the nearest constellation point with the estimated symbol, where constellation point A positioned at 0.707+0.707i is the nearest point with the estimated symbol as seen in FIG. and hence 0.707+0.707i is the output of Quant(.) in Equation (46) in this example. Furthermore, the noise variance vector v 844 can be obtained with the aid of a noise variance calculation circuit 843 by following Equation (44) and Equation (47).

After introducing the basic principles and operations illustrated in FIG. 8 for the proposed matrix-extension based MMSE-SIC with IRC equalizer, some functional blocks will be explicitly discussed in the following context.

In accordance with some examples described herein, four switches may be optionally applied in the MIMO equalizer circuit 800 shown in FIG. 8, wherein each switch supports two modes of operation under the direction of the controller 848 and sixteen combinations of the run-time modes can be supported by the four switches.

More explicitly, as shown in FIG. 8, the first switch 849 supports a first mode of operation wherein the covariance matrix input 200 which in this case contains both interference and noise as shown in the left-hand side example in FIG. 2 is used for equalisation following the MMSE-IRC criterion as detailed above and wherein the first switch 849 optionally supports a second mode of operation wherein the diagonal covariance matrix 201 as shown in the right-hand side example in FIG. 2 is generated from the fourth input of noise power scalar 124 and used for equalisation following the MMSE criterion under the direction of the controller 848. The fourth input of noise power scalar 124 is optional and a covariance matrix generation circuit 122 as shown in FIG. 8 is required for calculating a diagonal covariance matrix 201 as seen in the right-hand side covariance matrix example in FIG. 2.

The second switch 815 in FIG. 8 supports a third mode of operation wherein the inverse square root circuit detailed above is used, which may be based on the Schur decomposition expressed in Equation (33). Furthermore, the second switch 815 may optionally support a fourth mode of operation wherein a diagonal inverted square root matrix circuit 813 is used under the direction of the controller 848. Explicitly, the diagonal inverted square root matrix circuit only has to invert the square root of real-valued diagonal elements generated from the optional fourth input of noise power scalar 124 of a diagonal covariance matrix 201 as shown in the right-hand side covariance matrix example in FIG. 2 and produce a B2 matrix 814 that provides the inverted square root matrix R_{I}^{-1/2} 816. For example, a real-valued diagonal covariance matrix R_{I} of dimension (2×2) may be defined as shown in Equation (48)

$${R}_{I} = [ \begin{matrix}9 & 0 \\ 0 & 16\end{matrix} ] \qquad ( 48 )$$

the square root matrix R_{I}^{1/2} of the R_{I} matrix in Equation (48) can be expressed as:

$${R}_{I}^{1 / 2} = [ \begin{matrix}3 & 0 \\ 0 & 4\end{matrix} ] \qquad ( 49 )$$

And the inverted square root matrix R_{I}^{-1/2} of Equation (48) based on Equation (49) can be expressed as:

$${R}_{I}^{- 1 / 2} = [ \begin{matrix}\frac{1}{3} & 0 \\ 0 & \frac{1}{4}\end{matrix} ] \qquad ( 50 )$$

As a result of its lower complexity, the use of the diagonal inverted square root matrix circuit 813 would offer the benefit of reduced latency and reduced energy consumption. As an example, the fourth mode of operation can be adopted by the second switch 815 when the input is provided by a diagonal covariance matrix 201 generated from the optional fourth input of noise power scalar 124 and the third mode of operation can be used when the input is provided by the covariance matrix input 200 which in this case contains both the interference and the noise. Alternatively, the third mode of operation could be used when it is detected that there is only minimal interference in the received signal vector y 801, for example. Note that a skilled practitioner would recognise that the hardware complexity could be reduced by reusing circuitry between the Schur decomposition based inverse square root circuit and the diagonal inverted square root matrix circuit 813, with the second switch 815 being merged into the controller 848 for the resultant circuit.

Then, the third switch 847 in FIG. 6 supports a fifth mode of operation wherein the QRD circuit 826 is used in the SIC detection circuit as detailed above, and the permutation P matrix output of the QRD circuit 826 is an identity matrix which reveals the detection order is based on [N_{L}, . . . , 1] as described in step 1 of Algorithm-3. Furthermore, the third switch 847 optionally supports a sixth mode of operation wherein a sorted QRD (SQRD) circuit 830 is used for determining an optimized detection order, wherein the permutation P matrix which determines the optimized detection order is generated from the SQRD circuit 830 and will be used for permuting the order of the detected symbols after finishing the operation of Gaussian elimination under the direction of the controller 848. Explicitly, the detection order can be modified by permuting elements of x in Algorithm-3 and the corresponding columns of channel estimate matrix H prior to the QR decomposition in Equation (35), leading to an updated Q matrix and updated R matrix. In order to find the optimum sequence, the norm |hᵢ|² of a column vector hᵢ of the channel estimate H matrix needs to be maximised for i=N_{L}, . . . , 1, where the calculation and ordering of the norms |hᵢ|²(i=N_{L}, . . . , 1) happen before Equation (35) and the operations are only required once.

Specifically, a permutation M matrix of dimension (N_{L}×N_{L}) indicates the detection order according to the calculation of norms and is the variant of an identity matrix, where the M matrix has a single “1” in each row and in each column, with zeros everywhere else. More specifically, the fundamental idea of the sorting process in SQRD circuit 830 is that the successive layers detected during the SIC process can only propagate errors to the layers that are detected after them in the ordering. By detecting the layers in order of decreasing input SINR, the probability of error propagation and increase the output SINRs across the layers. The sorting process in the SQRD circuit 830 can be implemented by ordering the layers according to the norms of the N_{L} columns of the extended preprocessed channel estimate H3 matrix 823 in Equation (35), where the layer having the minimum norm will be detected first.

More explicitly, by applying the permutation M matrix to the equalized signal vector output 839 of the Gaussian elimination with quantization circuit 837, the equalized signal vector x 842 in Equation (46) can be updated as Mx and the noise variance vector v 844 in Equation (47) can be updated as Mv. Specifically, the fifth mode of operation is preferable to be enabled for removing the latency and power consumption that would otherwise be associated with the sorting operation. Furthermore, the decision for whether or not to enable sorting process could be controlled at run-time in a practical system according to the channel SINR, where it may be preferable to disable sorting process when the SINR is below a particular threshold and preferable to enable it when the SINR is above the threshold. A skilled practitioner would recognise that other features such as channel gains or covariance matrix properties could be used to control the decision.

Note that in a practical implementation, the QRD circuit 826 and the SQRD circuit 830 could be implemented separately, together with a physical implementation of the third switch 847. Alternatively, a skilled practitioner would recognise that the hardware complexity could be reduced by reusing circuitry between the QRD circuit 826 and the SQRD circuit 830, with the third switch 847 being merged into the controller 848 for the resultant circuit. Alternatively, the implementer of examples herein described may elect to adopt only the SQRD variant of the SIC detection circuit, without support for the QRD variant. In summary, there are three options for the SIC detection circuit 825: a first variant that uses only the QRD, a second variant that uses only the SQRD and a third variant that includes the third switch and allows run-time selections between the QRD and SQRD.

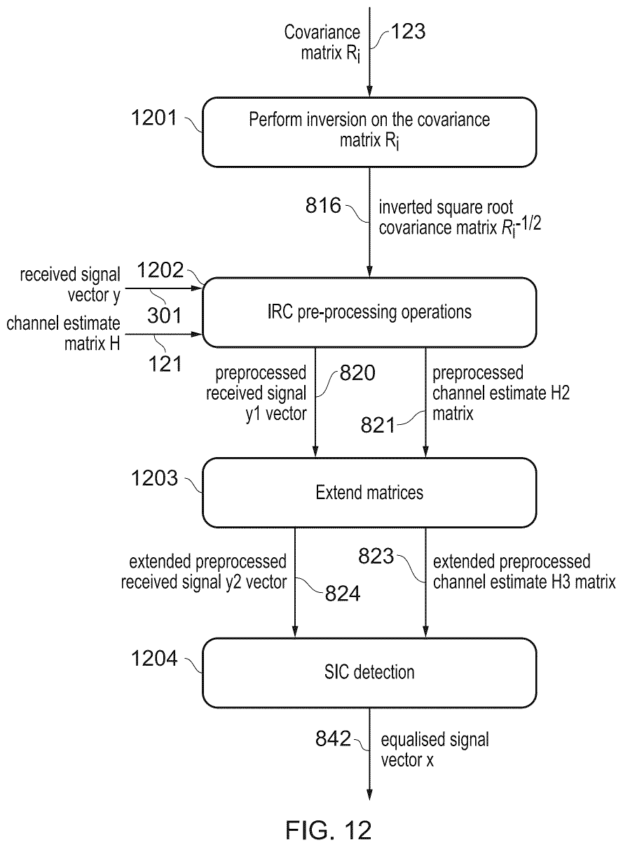

Furthermore, the fourth switch 841 in FIG. 8 supports a seventh mode of operation wherein the Gaussian elimination with quantization circuit 837 as described in the pseudo code of Algorithm-3 is used, and the fourth switch 841 optionally supports an eighth mode of operation wherein the Gaussian elimination without quantization circuit 838 is used under the direction of the controller 848 wherein the Quant(y₃(i)−dᵢ/μᵢ) function in Algorithm-3 is replaced with (y₃(i)−dᵢ)/μᵢ in Equation (46). The quantization operation is used to find the nearest QAM constellation point with the equalized symbol for further improving the detection reliability at the cost of a higher power consumption and a higher latency. The quantisation operation may be switched off when a lower power consumption and lower latency circuit is required. Note that in a practical implementation, the Gaussian elimination with quantisation circuit 837 and the Gaussian elimination without quantisation circuit 838 could be implemented separately, together with a physical implementation of the fourth switch may be reduced. Alternatively, a skilled practitioner would recognise that the hardware complexity could be reduced by reusing circuitry between the Gaussian elimination with quantisation circuit 837 and the Gaussian elimination without quantisation circuit 838, with the fourth switch being merged into the controller for the resultant circuit. In summary, a particular manifestation of examples for MIMO equalisation may be described by the flowchart 1200 of FIG. 12. The operation begins at 1201, where an inverted square root covariance matrix R_{I}^{-1/2} 816 is calculated as a function of a covariance matrix R_{I} 123. Following this, an IRC pre-processing operation is performed at 1202, which converts the inverted square root covariance matrix R_{I}^{-1/2} 816, a received signal vector y 301 and a channel estimate matrix H 121 into a preprocessed received signal y1 vector 820 and a preprocessed channel estimate H2 matrix 821. Following this, the preprocessed received signal y1 vector 820 and the preprocessed channel estimate H2 matrix 821 are extended at 1203, in order to generate an extended preprocessed received signal y2 vector 824 and an extended preprocessed channel estimate H3 matrix 823. Then an equalized signal vector x 842 is calculated and in some examples output at 1204 as part of the SIC detection and as a function of the extended preprocessed received signal y2 vector and the extended preprocessed channel estimate H3 matrix 823.

In accordance with some examples described herein, FIG. 9 presents an example simulation result based on the simulation configurations shown in FIG. 6 for the matrix-extension based MMSE-SIC MIMO equalizer, where the SINR gain over the linear MMSE criterion vs. SINR is presented. As shown in FIG. 9, based on our example simulations based on the 3GPP standard scenarios, the MMSE-IRC criterion has been demonstrated to have about 3 dB SINR gains over the linear MMSE criterion across a wide range of SINRs. In particular, the SINR gains are over 3 dB and even up to 9.2 dB over the linear MMSE criterion in the low SINR region. Furthermore, the proposed matrix-extension based MMSE-SIC MIMO equalizer has been able to provide up to 1.0 dB further SINR gains over MMSE-IRC criterion at medium SINR region.

### Applications

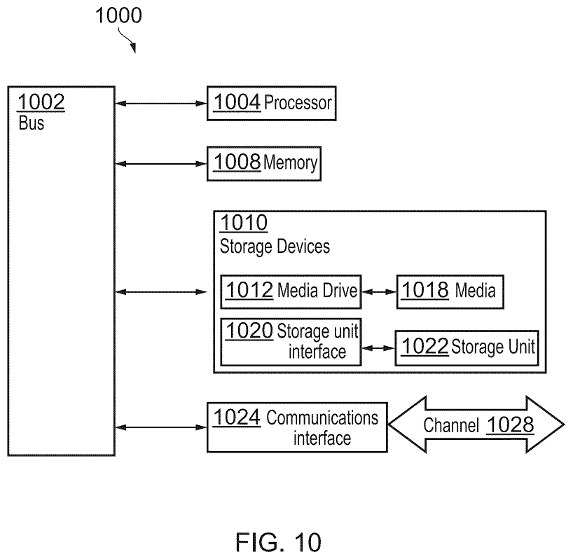

Referring now to FIG. 10, there is illustrated a typical computing system 1000 that may be employed to implement equalizer computation according to some example embodiments. Computing systems of this type may be used in wireless communication units. Those skilled in the relevant art will also recognize how to implement examples herein described using other computer systems or architectures. Computing system 1000 may represent, for example, a desktop, laptop or notebook computer, hand-held computing device (PDA, cell phone, palmtop, etc.), mainframe, server, client, or any other type of special or general purpose computing device as may be desirable or appropriate for a given application or environment. Computing system 1000 can include at least one processors, such as a processor 1004. Processor 1004 can be implemented using a general or special-purpose processing engine such as, for example, a microprocessor, microcontroller or other control logic. In this example, processor 1004 is connected to a bus 1002 or other communications medium. In some examples, computing system 1000 may be a non-transitory tangible computer program product comprising executable code stored therein for implementing equalizer computation.

Computing system 1000 can also include a main memory 1008, such as random access memory (RAM) or other dynamic memory, for storing information and instructions to be executed by processor 1004. Main memory 1008 also may be used for storing temporary variables or other intermediate information during execution of instructions to be executed by processor 1004. Computing system 1000 may likewise include a read only memory (ROM) or other static storage device coupled to bus 1002 for storing static information and instructions for processor 1004.

The computing system 1000 may also include information storage system 1010, which may include, for example, a media drive 1012 and a removable storage interface 1020. The media drive 1012 may include a drive or other mechanism to support fixed or removable storage media, such as a hard disk drive, a floppy disk drive, a magnetic tape drive, an optical disk drive, a compact disc (CD) or digital video drive (DVD) read or write drive (R or RW), or other removable or fixed media drive. Storage media 1018 may include, for example, a hard disk, floppy disk, magnetic tape, optical disk, CD or DVD, or other fixed or removable medium that is read by and written to by media drive 1012. As these examples illustrate, the storage media 1018 may include a computer-readable storage medium having particular computer software or data stored therein.

In alternative embodiments, information storage system 1010 may include other similar components for allowing computer programs or other instructions or data to be loaded into computing system 1000. Such components may include, for example, a removable storage unit 1022 and an interface 1020, such as a program cartridge and cartridge interface, a removable memory (for example, a flash memory or other removable memory module) and memory slot, and other removable storage units 1022 and interfaces 1020 that allow software and data to be transferred from the removable storage unit 1018 to computing system 1000.

Computing system 1000 can also include a communications interface 1024. Communications interface 1024 can be used to allow software and data to be transferred between computing system 1000 and external devices. Examples of communications interface 1024 can include a modem, a network interface (such as an Ethernet or other NIC card), a communications port (such as for example, a universal serial bus (USB) port), a PCMCIA slot and card, etc. Software and data transferred via communications interface 1024 are in the form of signals which can be electronic, electromagnetic, and optical or other signals capable of being received by communications interface 1024. These signals are provided to communications interface 1024 via a channel 1028. This channel 1028 may carry signals and may be implemented using a wireless medium, wire or cable, fibre optics, or other communications medium. Some examples of a channel include a phone line, a cellular phone link, an RF link, a network interface, a local or wide area network, and other communications channels.

In this document, the terms ‘computer program product’, ‘computer-readable medium’ and the like may be used generally to refer to media such as, for example, memory 1008, storage device 1018, or storage unit 1022. These and other forms of computer-readable media may store at least one instruction for use by processor 1004, to cause the processor to perform specified operations. Such instructions, generally referred to as ‘computer program code’ (which may be grouped in the form of computer programs or other groupings), when executed, enable the computing system 1000 to perform functions of examples herein described. Note that the code may directly cause the processor to perform specified operations, be compiled to do so, and/or be combined with other software, hardware, and/or firmware elements (e.g., libraries for performing standard functions) to do so.

In an embodiment where the elements are implemented using software, the software may be stored in a computer-readable medium and loaded into computing system 1000 using, for example, removable storage drive 1022, drive 1012 or communications interface 1024. The control logic (in this example, software instructions or computer program code), when executed by the processor 1004, causes the processor 1004 to perform the functions as described herein.

In the foregoing specification, examples have been described with reference to specific embodiments. It will, however, be evident that various modifications and changes may be made therein without departing from the scope of the invention as set forth in the appended claims and that the claims are not limited to the specific examples described above.

The connections as discussed herein may be any type of connection suitable to transfer signals from or to the respective nodes, units or devices, for example via intermediate devices. Accordingly, unless implied or stated otherwise, the connections may for example be direct connections or indirect connections. The connections may be illustrated or described in reference to being a single connection, a plurality of connections, unidirectional connections, or bidirectional connections. However, different embodiments may vary the implementation of the connections. For example, separate unidirectional connections may be used rather than bidirectional connections and vice versa. Also, plurality of connections may be replaced with a single connection that transfers multiple signals serially or in a time multiplexed manner. Likewise, single connections carrying multiple signals may be separated out into various different connections carrying subsets of these signals. Therefore, many options exist for transferring signals.

Those skilled in the art will recognize that the architectures depicted herein are merely exemplary, and that in fact many other architectures can be implemented which achieve the same functionality.

Any arrangement of components to achieve the same functionality is effectively ‘associated’ such that the desired functionality is achieved. Hence, any two components herein combined to achieve a particular functionality can be seen as ‘associated with’ each other such that the desired functionality is achieved, irrespective of architectures or intermediary components. Likewise, any two components so associated can also be viewed as being ‘operably connected,’ or ‘operably coupled,’ to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Examples have been herein described with reference to an integrated circuit device comprising, say, a microprocessor configured to perform the functionality of an equalizer computation. However, it will be appreciated that the examples herein described are not limited to such integrated circuit devices, and may equally be applied to integrated circuit devices comprising any alternative type of operational functionality. Examples of such integrated circuit device comprising alternative types of operational functionality may include, by way of example only, application-specific integrated circuit (ASIC) devices, field-programmable gate array (FPGA) devices, or integrated with other components, etc. Furthermore, because the illustrated embodiments may for the most part, be implemented using electronic components and circuits known to those skilled in the art, details have not been explained in any greater extent than that considered necessary, for the understanding and appreciation of the underlying concepts of examples herein described and in order not to obfuscate or distract from the teachings of the examples herein described. Alternatively, the circuit and/or component examples may be implemented as any number of separate integrated circuits or separate devices interconnected with each other in a suitable manner.

Also for example, the examples, or portions thereof, may implemented as soft or code representations of physical circuitry or of logical representations convertible into physical circuitry, such as in a hardware description language of any appropriate type.

Also, examples herein described are not limited to physical devices or units implemented in non-programmable hardware but can also be applied in programmable devices or units able to perform the desired equalizer computation by operating in accordance with suitable program code, such as minicomputers, personal computers, notepads, personal digital assistants, electronic games, automotive and other embedded systems, cell phones and various other wireless devices, commonly denoted in this application as ‘computer systems’.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms ‘a’ or ‘an,’ as used herein, are defined as at least one. Also, the use of introductory phrases such as ‘at least one’ in the claims should not be construed to imply that the introduction of another claim element by the indefinite articles ‘a’ or ‘an’ limits any particular claim containing such introduced claim element to inventions containing only one such element, even when the same claim includes the introductory phrases ‘at least one’ and indefinite articles such as ‘a’ or ‘an.’ The same holds true for the use of definite articles. Unless stated otherwise, terms such as ‘first’ and ‘second’ are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage. The word ‘subset’ refers to a selection of elements from a set, where that selection may comprise one, some or all of the elements in the set.

### REFERENCES

[1] “3rd Generation Partnership Project; Technical Specification Group Radio Access Network; Performance Requirements of MMSE-IRC receiver for LTE BS (Release 13)”, 3GPP TR 36.884 V13.1.0, September 2016.
[2] Yang, Lie-Liang. Multicarrier communications. John Wiley & Sons, 2009.
[3] Tavares, Fernando M L, et al. “On the potential of interference rejection combining in B4G networks.” 2013 IEEE 78th Vehicular Technology Conference (VTC Fall). IEEE, 2013.
[4] Zhu, X. and Murch, R. D., 2002. Performance analysis of maximum likelihood detection in a MIMO antenna system. IEEE Transactions on Communications, 50(2), pp. 187-191.

1-13. (canceled)

14. A multiple-input multiple-output, MIMO, equalizer circuit comprising:
a controller;
an inverse square root matrix circuit operably coupled to the controller and having a first input operable to receive a covariance matrix, R_{I}, and configured to perform an inverse square root operation to the covariance matrix, R_{I}, and output an inverted square root covariance matrix, R_{I}^{-1/2}, to a first output;
an interference rejection combining, IRC-preprocessing circuit operably coupled to the controller and the inverse square root matrix circuit and comprises a channel estimate matrix, H, input and a received signal vector, y, input wherein the IRC-preprocessing circuit is configured to:
multiply the inverted square root covariance matrix, R_{I}^{-1/2}, and a channel estimate matrix, H, that generates a preprocessed channel estimate, H2, matrix provided to a second output; and
multiply the inverted square root covariance matrix, R_{I}^{-1/2}, and the received signal vector, y, that generates a preprocessed received signal, y1, vector provided to a third output;
a matrix extension circuit operably coupled to the controller and the second output and third output of the IRC-preprocessing circuit, wherein the matrix extension circuit is configured to:
extend the preprocessed channel estimate, H2, matrix that produces a preprocessed channel estimate, H3, matrix provided to a fourth output; and
extend the preprocessed received signal, y1, vector that produces an extended preprocessed received signal, y2, vector provided to a fifth output; and
a successive interference cancellation, SIC, detection circuit operably coupled to the controller and the fourth output and fifth output of the matrix extension circuit, wherein the SIC detection circuit is configured to use the extended preprocessed channel estimate, H3, matrix to perform successive interference cancellation to the extended preprocessed received signal, y2, vector that produces an equalized signal vector, x;
wherein the inverse square root matrix circuit comprises:
a Schur decomposition circuit operably coupled to the first input and configured to convert the covariance matrix, R₁, into an orthogonal eigenvectors matrix, U, and a real-valued diagonal matrix, D;
an inverse square root circuit operably coupled to the Schur decomposition circuit and configured to perform an inverse square root operation that converts the real-valued diagonal matrix, D, into an inverted square root real-valued diagonal matrix, D^{-1/2}; and
a matrix manipulation circuit operably coupled to the Schur decomposition circuit and the inverse square root circuit and configured to generate a B1 matrix from the orthogonal eigenvectors matrix, U, and the inverted square root real-valued diagonal matrix, D^{-1/2}, to the first output.

15. The MIMO equalizer circuit of claim 14, wherein the covariance matrix, R_{I}, has a first dimension equal to a number of spatial streams, N_{R}, and a second dimension equal to the number of spatial streams, N_{R}, wherein the channel estimate matrix, H, has a first dimension equal to the number of spatial streams, N_{R}, and a second dimension equal to a number of layers, N_{L}, and wherein the received signal vector, y, has a length equal to the number of spatial streams, N_{R}, and the equalized signal vector, x, has a length equal to the number of layers, N_{L}.

16. The MIMO equalizer circuit of claim 15, wherein the number of spatial streams, N_{R}, and for the number of layers, N_{L}, vary between operations of the MIMO equalizer circuit at run-time.

17. The MIMO equalizer circuit of claim 15, wherein the inverted square root covariance matrix, R_{I}^{-1/2}, has a first dimension equal to the number of spatial streams, N_{R}, and a second dimension equal to the number of spatial streams, N_{R}, and wherein the preprocessed channel estimate, H2, matrix has a first dimension equal to the number of spatial streams, N_{R}, and a second dimension equal to the number of layers N_{L}, and wherein the y1 vector has a length equal to the number of spatial streams, N_{R}, and the extended preprocessed received signal, y2, vector has a length equal to the sum of the number of spatial streams and the number of layers, N_{R}+N_{L}, and wherein the extended preprocessed channel estimate, H3, matrix has a first dimension equal to a sum of the number of spatial streams and the number of layers, N_{R}+N_{L}, and a second dimension equal to the number of layers, N_{L}.

18. The MIMO equalizer circuit of claim 14, wherein the matrix manipulation circuit further comprises:
a Hermitian transpose circuit configured to perform a Hermitian transpose that converts the orthogonal eigenvectors matrix, U, into a Hermitian transposed, U2, matrix; and
a matrix multiplication circuit operably coupled to an output of the Hermitian transpose circuit and configured to convert the orthogonal eigenvectors matrix, U, the inverse square root real-valued diagonal matrix D^{-1/2}, and the Hermitian transposed, U2, matrix into the B1 matrix.

19. The MIMO equalizer circuit of claim 14, further comprising a first switch that operates under the direction of the controller, wherein:
in a first mode of operation the first switch is configured to receive and output the covariance matrix, R_{I}; and
in a second mode of operation the MIMO equalizer further comprises a covariance matrix generator circuit operably coupled to the first switch and configured to receive a noise power scalar, wherein the covariance matrix generator circuit uses the noise power scalar to generate a diagonal covariance matrix that is provided to the first switch and the first switch outputs the diagonal covariance matrix as the covariance matrix, R_{I}.

20. The MIMO equalizer circuit of claim 14, wherein the inverse square root matrix circuit further comprises a second switch operably coupled to the controller and a diagonal inverse square root circuit and configured to support:
a third mode of operation wherein the B1 matrix provides the inverted square root covariance matrix, R_{I}^{-1/2}; and
a fourth mode of operation wherein the diagonal inverse square root circuit performs a diagonal inverse square root operation that converts the covariance matrix, R₁, into a B2 matrix and wherein the B2 matrix provides the inverted square root covariance matrix, R_{I}^{-1/2}.

21. The MIMO equalizer circuit of claim 14, wherein the SIC detection circuit further comprises:
a QR decomposition, QRD, circuit operable to perform a QR decomposition that converts the extended preprocessed channel estimate, H3, matrix into an orthogonal unitary matrix, Q, and an upper triangular matrix, R, under direction of the controller, and
a Gaussian elimination circuit operably coupled to the QRD, circuit and configured to perform Gaussian elimination that converts the orthogonal unitary matrix, Q, the upper triangular matrix R and the extended preprocessed received signal, y2, vector into the equalized signal vector output under direction of the controller.

22. The MIMO equalizer circuit of claim 21, wherein the SIC detection circuit comprises a third switch operably coupled to the controller and the controller configures the SIC detection circuit via the third switch to operate in:
a fifth mode of operation, when the QRD circuit does not employ a sorting process; and
a sixth mode of operation when the QRD circuit does employ a sorting process.

23. The MIMO equalizer circuit of claim 21, wherein the Gaussian elimination circuit is operably coupled to a fourth switch operably coupled to the controller and the controller configures the Gaussian elimination circuit via the fourth switch to operate in a seventh mode of operation that employs quantization and an eighth mode of operation where the Gaussian elimination circuit does not employ quantization.

24. The MIMO equalizer circuit of claim 21, further comprising a noise variance calculation circuit operably coupled to the controller and configured to convert the upper triangular matrix, R, and the orthogonal unitary matrix, Q, into a noise variance vector, v, under the direction of the controller.

25. A communication unit comprising a multiple-input multiple-output, MIMO, equalizer circuit comprising:
a controller;
an inverse square root matrix circuit operably coupled to the controller and having a first input operable to receive a covariance matrix, R_{I}, and configured to perform an inverse square root operation to the covariance matrix, R_{I}, and output an inverted square root covariance matrix, R_{I}^{-1/2}, to a first output;
an interference rejection combining, IRC-preprocessing circuit operably coupled to the controller and the inverse square root matrix circuit and comprises a channel estimate matrix, H, input and a received signal vector, y, input wherein the IRC-preprocessing circuit is configured to:
multiply the inverted square root covariance matrix, R_{I}^{-1/2}, and a channel estimate matrix, H, that generates a preprocessed channel estimate, H2, matrix provided to a second output; and
multiply the inverted square root covariance matrix, R_{I}^{-1/2}, and the received signal vector, y, that generates a preprocessed received signal, y1, vector provided to a third output;
a matrix extension circuit operably coupled to the controller and the second output and third output of the IRC-preprocessing circuit, wherein the matrix extension circuit is configured to:
extend the preprocessed channel estimate, H2, matrix that produces a preprocessed channel estimate, H3, matrix provided to a fourth output; and
extend the preprocessed received signal, y1, vector that produces an extended preprocessed received signal, y2, vector provided to a fifth output; and
a successive interference cancellation, SIC, detection circuit operably coupled to the controller and the fourth output and fifth output of the matrix extension circuit, wherein the SIC detection circuit is configured to use the extended preprocessed channel estimate H3 matrix to perform successive interference cancellation to the extended preprocessed received signal, y2, vector that produces an equalized signal vector, x;
wherein the inverse square root matrix circuit comprises:
a Schur decomposition circuit operably coupled to the first input and configured to convert the covariance matrix, R_{I}, into an orthogonal eigenvectors matrix, U, and a real-valued diagonal matrix, D;
an inverse square root circuit operably coupled to the Schur decomposition circuit and configured to perform an inverse square root operation that converts the real-valued diagonal matrix, D, into an inverted square root real-valued diagonal matrix, D^{-1/2}; and
a matrix manipulation circuit operably coupled to the Schur decomposition circuit and the inverse square root circuit and configured to generate a B1 matrix from the orthogonal eigenvectors matrix, U, and the inverted square root real-valued diagonal matrix D^{-1/2} to the first output.

26. The communication unit of claim 25, wherein the covariance matrix, R_{I}, has a first dimension equal to a number of spatial streams, N_{R}, and a second dimension equal to the number of spatial streams, N_{R}, wherein the channel estimate matrix, H, has a first dimension equal to the number of spatial streams, N_{R}, and a second dimension equal to a number of layers, N_{L}, and wherein the received signal vector, y, has a length equal to the number of spatial streams, N_{R}, and the equalized signal vector, x, has a length equal to the number of layers, N_{L}.

27. The communication unit of claim 26, wherein the number of spatial streams, N_{R}, and for the number of layers, N_{L}, vary between operations of the MIMO equalizer circuit at run-time.

28. The communication unit of claim 26, wherein the inverted square root covariance matrix, R_{I}^{-1/2}, has a first dimension equal to the number of spatial streams, N_{R}, and a second dimension equal to the number of spatial streams, N_{R}, and wherein the preprocessed channel estimate, H2, matrix has a first dimension equal to the number of spatial streams, N_{R}, and a second dimension equal to the number of layers N_{L}, and wherein the y1 vector has a length equal to the number of spatial streams, N_{R}, and the extended preprocessed received signal, y2, vector has a length equal to the sum of the number of spatial streams and the number of layers, N_{R}+N_{L}, and wherein the extended preprocessed channel estimate, H3, matrix has a first dimension equal to a sum of the number of spatial streams and the number of layers, N_{R}+N_{L}, and a second dimension equal to the number of layers, N_{L}.

29. The communication unit of claim 25, wherein the matrix manipulation circuit further comprises:
a Hermitian transpose circuit configured to perform a Hermitian transpose that converts the orthogonal eigenvectors matrix, U, into a Hermitian transposed U2 matrix; and
a matrix multiplication circuit operably coupled to an output of the Hermitian transpose circuit and configured to convert the orthogonal eigenvectors matrix, U, the inverse square root real-valued diagonal matrix D^{-1/2}, and the Hermitian transposed, U2, matrix into the B1 matrix.

30. A method of performing multiple-input multiple-output, MIMO, equalization comprising:
at an inverse square root matrix circuit:
receiving a covariance matrix, R_{I};
converting, by a Schur decomposition circuit, the covariance matrix, R_{I}, into an orthogonal eigenvectors matrix, U, and a real-valued diagonal matrix, D;
performing an inverse square root operation that converts the real-valued diagonal matrix, D, into an inverted square root real-valued diagonal matrix D^{-1/2}, by an inverse square root circuit operably coupled to the Schur decomposition circuit;
generating a B1 matrix from an orthogonal eigenvectors matrix, U, and the inverted square root real-valued diagonal matrix, D^{-1/2}, by a matrix manipulation circuit operably coupled to the Schur decomposition circuit and the inverse square root circuit; and
outputting an inverted square root covariance matrix, R_{I}^{-1/2};
receiving by an interference rejection combining, IRC-preprocessing circuit the inverted square root covariance matrix, R_{I}^{-1/2}, a channel estimate matrix H, and a received signal vector, y;
multiplying the inverted square root covariance matrix, R_{I}^{-1/2}, and the channel estimate matrix, H, and generating a preprocessed channel estimate, H2, matrix;
multiplying the inverted square root covariance matrix, R_{I}^{-1/2}, and the received signal vector y and generating a preprocessed received signal, y1, vector;
extending the preprocessed channel estimate, H2, matrix by a matrix extension circuit and producing a preprocessed channel estimate, H3, matrix;
extending the preprocessed received signal, y1, vector and producing an extended preprocessed received signal, y2, vector; and
receiving by a successive interference cancellation, SIC, detection circuit the extended preprocessed channel estimate, H3, matrix, and using the extended preprocessed channel estimate, H3, matrix to perform successive interference cancellation to the extended preprocessed received signal, y2, vector and outputting an equalized signal vector x.

31. The method of claim 30, wherein the covariance matrix, R_{I}, has a first dimension equal to a number of spatial streams, N_{R}, and a second dimension equal to the number of spatial streams, N_{R}, wherein the channel estimate matrix, H, has a first dimension equal to the number of spatial streams, N_{R}, and a second dimension equal to a number of layers, N_{L}, and wherein the received signal vector, y, has a length equal to the number of spatial streams, N_{R}, and the equalized signal vector, x, has a length equal to the number of layers, N_{L}.

32. The method of claim 31, wherein the number of spatial streams, N_{R}, and for the number of layers, N_{L}, vary between operations of the MIMO equalizer circuit at run-time.

33. The method of claim 31, wherein the inverted square root covariance matrix, R_{I}^{-1/2}, has a first dimension equal to the number of spatial streams, N_{R}, and a second dimension equal to the number of spatial streams, N_{R}, and wherein the preprocessed channel estimate, H2, matrix has a first dimension equal to the number of spatial streams, N_{R}, and a second dimension equal to the number of layers N_{L}, and wherein the y1 vector has a length equal to the number of spatial streams, N_{R}, and the extended preprocessed received signal, y2, vector has a length equal to the sum of the number of spatial streams and the number of layers, N_{R}+N_{L}, and wherein the extended preprocessed channel estimate, H3, matrix has a first dimension equal to a sum of the number of spatial streams and the number of layers, N_{R}+N_{L}, and a second dimension equal to the number of layers, N_{L}.
